(19) United States
(12) Patent Application Publication
(10) Pub. No.: US 2025/0043132 A1
(43) Pub. Date: Feb. 6, 2025

(54) ENGINEERED WOOD ADHESIVES INCLUDING GLYCEROL OR OLIGOMERS OF GLYCEROL AND ENGINEERED WOOD THEREFROM

(71) Applicant: CARGILL, INCORPORATED, Wayzata, MN (US)

(72) Inventors: David Edward GARLIE, Eau Clarie, WI (US); Flave Eugene MARKLAND, Jr., Atkins, IA (US); Shuang ZHOU, Marion, IA (US)

(73) Assignee: CARGILL, INCORPORATED, Wayzata, MN (US)

(21) Appl. No.: 18/258,624

(22) PCT Filed: Dec. 23, 2021
(86) PCT No.: PCT/US2021/065099

§ 371 Date: Jun. 21, 2023

Related U.S. Application Data
(60) Provisional application No. 63/130,200, filed on Dec. 23, 2020.

(51) Int. Cl. C08L 97/02; B32B 21/02; B32B 21/13; C08K 3/32; C08K 3/38

(52) U.S. Cl. CPC C08L 97/02; B32B 21/02; B32B 21/13; C08K 3/32; C08K 3/38; B32B 2260/026; B32B 2260/046; C08K 2003/324; C08K 2003/387; C08L 2205/16

(57) ABSTRACT

The instant disclosure relates to an engineered wood precursor mixture. The engineered wood precursor mixture can include a plurality of wood components and a binder reaction mixture. The binder reaction mixture is present in a range of from 3 parts to 25 parts per 100 parts of the dry weight of the plurality of wood components. The binder reaction mixture includes an aqueous portion including a glycerol component. The glycerol component includes glycerol or an oligomer of glycerol in a range of from 5 wt % to 65 wt % or 5 wt % to 50 wt %, based on the dry weight of the binder reaction mixture. The binder reaction mixture further includes an at least partially non-dissolved polypeptide-containing component comprising soy flour, wheat gluten, corn protein isolate, or a mixture thereof, in a range of from 20 wt % to 85 wt %, based on the dry weight of the binder reaction mixture.

### CROSS-REFERENCE TO RELATED APPLICATIONS

This application claims the benefit of U.S. Provisional Patent Application No. 63/130,200, filed Dec. 23, 2020, which is incorporated by reference herein in its entirety.

### BACKGROUND

The most commonly used wood adhesives are phenol-formaldehyde resins (PF) and urea-formaldehyde resins (UF). There are at least two concerns with PF and UF resins. First, volatile organic compounds (VOC) are generated during the manufacture and use of lignocellulosic-based composites. An increasing concern about the effect of emissive VOC, especially formaldehyde, on human health has prompted a need for more environmentally acceptable adhesives. Second, PF and UF resins are made from petrochemical products (e.g., petroleum-derived products or natural gas derived products). The reserves of petroleum are naturally limited. The wood composite industry would greatly benefit from the development of formaldehyde-free adhesives made from renewable natural resources.

### SUMMARY OF THE INVENTION

Various aspects of the instant disclosure relate to an engineered wood precursor mixture. The engineered wood precursor mixture includes a plurality of wood components and a binder reaction mixture. The binder reaction mixture is present in a range of from 3 parts to 25 parts per 100 parts of the dry weight of the plurality of wood components. The binder reaction mixture includes an aqueous portion including a glycerol component. The glycerol component includes glycerol or an oligomer of glycerol, the glycerol component is present in a range of from 5 wt % to 65 wt % or 5 wt % to 50 wt %, (e.g., from 5 wt % to 65 wt %, from 10 wt % to 30 wt %, from 20 wt % to 30 wt %, at least 5 wt %, at least 10 wt %, at least 20 wt %, or at least 30 wt %) based on the dry weight of the binder reaction mixture. The binder reaction mixture further includes an at least partially non-dissolved polypeptide-containing component comprising soy flour, wheat gluten, corn protein isolate, or a mixture thereof, in a range of from 20 wt % to 85 wt %, based on the dry weight of the binder reaction mixture. In some aspects, the glycerol component includes 30 wt % to 95 wt % glycerol, 1 wt % to 15 wt % water, and 1 to 15 wt % NaCl and optionally 0.05 wt % to 0.25 wt % methanol and 0.1 wt % to 3 wt % organic residue.

Various aspects of the instant disclosure relate to an engineered wood precursor mixture. The engineered wood precursor mixture includes a plurality of wood components and a binder reaction mixture. The binder reaction mixture is present in a range of from 3 parts to 25 parts per 100 parts of the dry weight of the plurality of wood components. The binder reaction mixture includes an aqueous portion including a glycerol component. The glycerol component includes glycerol or an oligomer of glycerol, the glycerol component is present in a range of from 5 wt % to 65 wt % or 5 wt % to 50 wt %, (e.g., from 5 wt % to 65 wt %, from 20 wt % to 50 wt %, from 20 wt % to 40 wt %, from 10 wt % to 30 wt %, from 20 wt % to 30 wt %, at least 5 wt %, at least 10 wt %, at least 20 wt %, or at least 30 wt %) based on the dry weight of the binder reaction mixture. The glycerol component typically comprises at least 80 wt % glycerol on a dry weight basis (for example, at least 85 wt %, at least 90 wt %, or at least 95 wt % on a dry weight basis). The aqueous portion further includes a base in a range of 1 wt % to 33 wt % of a base, based on a dry weight of the binder reaction mixture. The aqueous portion further includes an optional carbohydrate-containing component in a range of from 2 wt % to 40 wt % or 2 wt % to 30 wt % (for example, at least 10 wt %, at least 15 wt %, or at least 20 wt % and typically less than 40 wt % or less than 30 wt %), based on a dry weight of the binder reaction mixture. The carbohydrate-containing component can include glucose, fructose, sucrose, or a mixture thereof, and the combined wt % of glucose, fructose, sucrose, or mixture thereof in the carbohydrate-containing component is at least 60 wt %. The aqueous portion, optionally, furthers include sodium sulfite in a range of from 0.5 wt % to 10 wt %, based on a dry weight of the binder reaction mixture. The binder reaction mixture further includes an at least partially non-dissolved polypeptide-containing component. The at least partially non-dissolved polypeptide-containing component includes soy flour, wheat gluten, corn protein isolate, or a mixture thereof, in a range of from 20 wt % to 85 wt %, based on the dry weight of the binder reaction mixture.

According to various aspects, a method of making an engineered wood includes, (a) mixing a glycerol component comprising glycerol or an oligomer of glycerol, water, a base, and optionally, sodium sulfite, a carbohydrate-containing component, borax, sodium trimetaphosphate, or a mixture thereof, to produce a first mixture. The method further includes, (b) mixing the first mixture produced at (a) with a plurality of wood components to obtain a second mixture. The method further includes (c), mixing the second mixture produced at (b) with a polypeptide-containing component to form a third mixture. The method further includes (d), curing the third mixture formed at (c) to form the engineered wood.

According to various aspects, an engineered wood can include a reaction product of an engineered wood precursor mixture. The engineered wood precursor mixture can include a plurality of wood components and a binder reaction mixture. The binder reaction mixture is present in a range of from 3 parts to 25 parts per 100 parts of the dry weight of the plurality of wood components. The binder reaction mixture includes an aqueous portion including a glycerol component. The glycerol component includes glycerol or an oligomer of glycerol, the glycerol component is present in a range of from 5 wt % to 65 wt % or 5 wt % to 50 wt %, (e.g., from 5 wt % to 65 wt %, from 10 wt % to 30 wt %, from 20 wt % to 30 wt %, at least 5 wt %, at least 10 wt %, at least 20 wt %, or at least 30 wt %) based on the dry weight of the binder reaction mixture. The binder reaction mixture further includes an at least partially non-dissolved polypeptide-containing component comprising soy flour, wheat gluten, corn protein isolate, or a mixture thereof, in a range of from 20 wt % to 85 wt %, based on the dry weight of the binder reaction mixture.

Typically, during curing, a platen is heated to a temperature of at least 100° C., for example, at least 120° C., or at least 187° C. in a range of from 100° C. to 250° C., in a range of from 180° C. to 220° C. or in a range of from 120° C. to 190° C. In some examples, the platen is heated to achieve a curing temperature of at least 198° C., at least 204° C., at least 246° C. in a range of from 198° C. to 232° C., 204° C. to 226° C., 210° C. to 221° C., less than 315° C., or preferably less than 230° C. Typically the platen is heated to achieve a curing temperature in a range of from 204° C. to 248° C., 210° C. to 243° C., 210° C. to 226° C., at least 215° C., or at least 251° C.

As used herein “mixing” means that the components are combined or added to each other to effect combination. For example, “mixing” can include spraying at least one component to another component. For example, “mixing” can include stirring a plurality of the components.

As used herein “mixture” means a portion of matter including two or more chemical substances.

### DETAILED DESCRIPTION OF THE INVENTION

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting: information that is relevant to a section heading may occur within or outside of that particular section.

The term “substantially” as used herein refers to a majority of, or mostly, as in at least about 90%, 95%, 99.5%, or 100%. The term “substantially free of” as used herein can mean having none or having a trivial amount of, such that the amount of material present does not affect the material properties of the composition including the material, such that about 0) wt % to about 5 wt % of the composition is the material, or about 0 wt % to about 1 wt %, or about 5 wt % or less, or about 0 wt %.

According to various aspects of the instant disclosure, an engineered wood product is described. The engineered wood product can typically take the form of a particle board, medium density fiber board, high density fiberboard, oriented strand board, engineered wood flooring, and combinations thereof. In preferred aspects, the engineered wood product takes the form of a particle board. The engineered wood product can be sized to have any suitable dimensions. For example, the engineered wood product can be sized to be 1.2 meters wide and 2.6 meters long, or 1.3 meters wide and 2.1 meters long. These dimensions are merely meant to be examples and do not limit the sizes of engineered wood products that can be produced. A density of the engineered wood is from 0.2 g/cm³ to 0.8 g/cm³, 0.60 g/cm³ to 0.75 g/cm³, 0.65 g/cm³ to 0.75 g/cm³, or from 0.65 g/cm³ to 0.70 g/cm³. Wood particles of face layers typically have a smaller average particle size than the wood particles of the core layer. Smaller wood particles in the face layers result in the face layers having a higher density than the core layer. It is expected that the density of the first face layer, second face layer or both is higher than a density of the core layer. Without intending to be bound to any theory, it is thought that the higher density in the face layers, relative to the core layers, may lead to improvement in the overall balance of the physical properties of the engineered wood product.

The engineered wood product can typically include a variety of constituents. For example, the engineered wood product can typically include a plurality of wood components bound together by a binder that is a reaction product of a binder reaction mixture including an at least partially non-dissolved polypeptide component distributed about the binder reaction mixture as well as an aqueous portion including a glycerol component including a glycerol or an oligomer of glycerol. As understood an oligomer of glycerol can include 2 to 8 glycerol repeating units, 3 to 7 glycerol repeating units, or 3 to 5 glycerol repeating units. The aqueous portion can further include a carbohydrate-containing component, sodium sulfite, sodium bisulfite, sodium metabisulfite, sodium trimetaphosphate, a borax, calcium carbonate, a base, or a mixture thereof. In the engineered wood product, the binder that is the reaction product of the binder reaction mixture, can typically be present in a range of from 3 parts to 25 parts binder per 100 parts of the dry weight of the WF, for example from 4.5 parts to 23.5 parts, 3 parts to 20 parts, or 6 parts to 17 parts or 8 parts to 17 parts 100 parts of dry weight of the wood components. Having levels of binder in these ranges can contribute to the engineered wood product having favorable or desirable physical properties, while effectively minimizing the amount of binder that is needed to bind the plurality of wood components. The binder can be characterized as a biopolymer.

Examples of desirable physical properties of the engineered wood products described herein can include the product's modulus of rupture (MOR), Modulus of Elasticity (MOE), Thickness Swell Percent (Thickness swell %), or a combination thereof as measured for example in the Working Examples. The modulus of rupture of the engineered wood product measures the amount of force required to result in rupturing the engineered wood product. The modulus of rupture can be measured, for example, according to ASTM D1037-06a. While the modulus of rupture value can depend on a variety of factors, including the engineered wood product's density, length, width, thickness, or a combination thereof, the modulus of rupture can generally be at least 800 psi or in a range of from 800 psi to 2000 psi or from 800 psi to 1900 psi.

The modulus of elasticity is a quantity that measures engineered wood product's resistance to being deformed elastically (e.g., non-permanently) when a stress is applied to it. The modulus of elasticity can be measured, for example, according to ASTM D1037-06a as described in the examples herein. While the modulus of elasticity value typically depends on a variety of factors, including the engineered wood product's density, length, width, thickness, or a combination thereof, the modulus of elasticity can be at least 0.1 Mpsi in a range of from 0.1 Mpsi to 0.4 Mpsi or from 0.2 Mpsi to 0.35 Mpsi.

The thickness swell % is a quantity that measures the engineered wood product's resistivity to water penetration. The higher the value, the greater the amount of water that is penetrated. This can result in the engineered wood product swelling or otherwise deforming. For example, the engineered wood product may expand past a desired amount. This can be undesirable, if the engineered wood product has precise features such as bore holes, flanges, grooves, or the like, that are designed to fit precisely with a corresponding feature on another product. The thickness swell % value can be measured, for example, according to ASTM D1037-06a as described in the examples herein. According to some aspects, the thickness swell % after soaking the engineered wood in water for two hours can be as low as zero. However, other acceptable values include those in a range of from 5% to 40% or from 15% to 25%, measured after soaking the engineered wood in water for two hours.

The internal bond strength is a quantity that measures a material's ability to resist rupturing in the direction perpendicular to the plane of the material's surface. The internal bond strength can be measured by ASTM D 1037-06a, as described in the examples herein. The engineered wood shows internal bond strength values of at least 40 psi, in a range of 40 psi to 120 psi or 40 psi to 90 psi or 50 psi to 90 psi, or 50 psi to 75 psi.

A benefit, of using the engineered wood products formed using the materials and methods described herein, is that the properties of the engineered wood products, typically are generally comparable to those of a corresponding engineered wood product differing in that it uses a urea-formaldehyde (UF) binder or a methylene diphenyl diisocyanate binder. Urea-formaldehyde resin is a synthetic resin produced by the chemical combination of formaldehyde (a gas produced from methane) and urea (a solid crystal produced from ammonia). Urea-formaldehyde resins are used mostly for gluing plywood, particleboard, and other wood products. Urea-formaldehyde resins polymerize into permanently interlinked networks which are influential in the strength of the cured adhesive. After setting and hardening, urea-formaldehyde resins form an insoluble, three-dimensional network and cannot be melted or thermo-formed.

However, there are a number of disadvantages associated with using urea-formaldehyde or methylene diphenyl diisocyanate. For example, addition of water, in high temperature, cured urea-formaldehyde can hydrolyze and release formaldehyde, this weakens the glue bond and can be toxic. Moreover, urea-formaldehyde must be used in a well ventilated area because uncured resin is irritating and can be toxic. Additionally, urea-formaldehyde adhesives generally have a limited shelf life.

The materials described herein can address at least some of these draw backs and, in particular, prevent the outgassing of substantially any formaldehyde or methylene diphenyl diisocyanate. Moreover, according to various aspects, the modulus of rupture, the thickness swell %, modulus of elasticity, internal bond strength, or a combination thereof of the engineered wood can be substantially similar to a modulus of elasticity, modulus of rupture, a thickness swell %, internal bond strength, or a combination thereof of a corresponding engineered wood differing in that the reaction product comprises urea-formaldehyde, methylene diphenyl diisocyanate binder, or a mixture thereof. More specifically, the thickness swell %, modulus of elasticity, modulus of rupture, internal bond strength, or a combination thereof of the engineered wood can be within 1% to 10%, 1% to 5%, or is substantially identical to the modulus of elasticity, modulus of rupture, the thickness swell %, internal bond strength, or a combination thereof of the corresponding engineered wood differing in that the reaction product comprises urea-formaldehyde, methylene diphenyl diisocyanate binder, or a mixture thereof. However, in a further aspect, the modulus of elasticity, the modulus of rupture, the thickness swell %, the internal bond strength, or a combination thereof can be within 50% to 150% of the corresponding engineered wood differing in that the reaction product comprises urea-formaldehyde, methylene diphenyl diisocyanate binder, or a mixture thereof.

The properties of the engineered wood products described herein can be further achieved or enhanced for example by distributing the binder such that it is substantially homogenously distributed about the plurality of wood components. Other properties such as the thickness swell % can typically be achieved or enhanced by adding a swell-retardant agent such that it is distributed about the engineered wood. The swell-retardant agent can include a wax emulsion that can sustain (e.g., remain stable) a high pH environment that is greater than 10. Where present, the swell-retardant can be from 0.1 wt % to 1 wt % or from 0.5 wt % to 0.7 wt % of the engineered wood product.

Although the engineered wood product has been described as a singular object, it is within the scope of this disclosure for the engineered wood product to be a component of a larger structure. For example, the engineered wood product can be part of a laminate structure where the engineered wood product constitutes an inner or outer layer of the laminate structure. The engineered wood product can be in contact with a core structure (e.g., a wood, plastic, or metal core) or another engineered wood product that has a substantially identical construction or a different construction.

The engineered wood described herein is formed from an engineered wood precursor mixture. The engineered wood precursor mixture includes a least a plurality of wood components, an aqueous portion of a binder reaction mixture and a peptide-containing component distributed about the binder reaction mixture. The plurality of wood components can include one or more wood particles, one or more wood components, one or more wood chips, or one or more wood strands. The wood components can include a wood material such as pine, hemlock, spruce, aspen, birch, maple, or mixtures thereof.

The glycerol component, including glycerol or an oligomer of glycerol, can be present in the aqueous portion of the binder reaction mixture. The glycerol component can be present in a range of from 5 wt % to 65 wt % or 5 wt % to 50 wt % based on the dry weight of the binder reaction mixture, or 20 wt % to 45 wt % or 25 wt % to 40 wt % or 5 wt % to 65 wt %, 10 wt % to 30 wt %, 20 wt % to 30 wt %, at least 5 wt %, at least 10 wt %, at least 20 wt %, or at least 30 wt %, based on a dry weight of the binder reaction mixture. The glycerol or oligomer of glycerol can include pure glycerol or an oligomer of glycerol. In some aspects, the glycerol or oligomer of glycerol can be diluted. For example, in some aspects the glycerol component can include a crude glycerol. A crude glycerol can include 30 wt % to 95 wt % glycerol or 55 wt % to 95 wt % glycerol. An exemplary example of a crude glycerol is a mixture including 10 to 20 wt % water (for example 15 wt %), 3 wt % to 7 wt % NaCl (for example 4 wt % to 5 wt %) and 80 wt % to 92 wt % glycerol (for example 87.5 wt %). A crude glycerol may include additional materials known to one of skill in the art. In some aspects, the crude glycerol can include less than 3 wt %, less than 2 wt %, or less than 1 wt % NaCl, this can be beneficial if the wood product used is a recycled wood particle. In some aspects, the glycerol can be a technical glycerol that includes a high concentration of glycerol and less than 1 wt % methanol, less than 0.5 wt % methanol, or less than 0.1 wt % methanol and less than 1 wt % NaCl, less than 0.5 wt % NaCl, or less than 0.1 wt % NaCl. In some aspects, the technical glycerol includes at least 98 wt % glycerol. Advantageously, it is found that binders including crude glycerol can yield superior or at least equivalent performance in a binder compared to a binder using pure glycerol or a pure oligomer of glycerol.

The carbohydrate-containing component can be in an aqueous form in a range of from 2 wt % to 40 wt % or 2 wt % to 30 wt % based on a dry weight of the binder reaction mixture or from 5 wt % to 25 wt % or from 5 wt % to 20 wt %. The carbohydrate-containing component includes glucose, fructose, sucrose, or a mixture thereof. The carbohydrate-containing component does not include glycerol or an oligomer of glycerol. In the carbohydrate-containing component, the combined wt % of glucose, fructose, sucrose, or mixture thereof in the carbohydrate-containing component is at least 60 wt %, at least 80 wt %, at least 85 wt %, at least 90 wt %, or even at least 94 wt %. In some aspects, the carbohydrate-containing component includes a glucose syrup, high fructose corn syrup, a starch (e.g., a cationic starch) a sucrose containing composition, or a mixture thereof. In some aspects the carbohydrate-containing component includes a monosaccharide such as glucose, fructose or mixtures thereof and the total weight percent of glucose and fructose is in the range of 20 wt % to 40 wt % based on dry weight of the binder reaction mixture. In some aspects, the carbohydrate-containing component includes a glucose syrup having a dextrose equivalent (DE) of at least 60, at least 80, at least 85, at least 90, or at least 95. As understood herein, dextrose equivalent is a measure of the amount of reducing sugars present in a sugar product, expressed as a percentage on a dry basis relative to dextrose. In some further aspects, the carbohydrate-containing component includes a high fructose corn syrup comprising at least 90 wt % fructose and glucose. In some aspects, the high fructose corn syrup can include at least 94 wt % fructose and glucose. In some aspects, the high fructose corn syrup includes from 30 wt % to 70 wt % glucose or from 35 wt % to 65 wt % glucose.

Typically, the carbohydrate(s) of the carbohydrate-containing component will be a carbohydrate that has at least one reducing group (the reducing group can be a reducing end group in some aspects). It is possible for the carbohydrate-containing component to have a mixture of carbohydrates with a reducing group and carbohydrates without a reducing group too, but in these cases there are likely to be at least some carbohydrates with a reducing group. The reducing group(s) (e.g., aldehyde group(s), ketone group(s), or a mixture thereof) available on the carbohydrates allows for a bond to formed between it and an amine group of the polypeptide component during curing to form a biopolymer or network thereof. It was found that using monosaccharides in the carbohydrate-containing component, in particular, led to improvement in the thickness swell %, modulus of rupture, and modulus of elasticity of the resulting engineered wood. Examples of further compounds that can be present in the carbohydrate include sorbitol, isosorbide, ethylene glycol, erythritol, inositol, pentaerythritol, or a mixture thereof.

When the binder reaction mixture includes at least the glycerol or oligomer of glycerol and the carbohydrate-containing component. The combined concentration can be in a range of from 20 wt % to 70 wt % or 20 wt % to 50 wt %, based on the dry weight of the binder reaction mixture or about 30 wt % to 45 wt %, based on the dry weight of the binder reaction mixture. Without intending to be bound by any theory, it is suspected that the combination of a glycerol or oligomer of glycerol and carbohydrate-containing component can have a synergistic effect to enhance the strength of the engineered wood. In particular if the carbohydrate-containing component includes reducing sugars, they may undergo a Maillard reaction with the polypeptide-containing component to further increase the strength of the engineered wood. For example, including the carbohydrate-containing component can help to increase the modulus of elasticity of the engineered wood, however adding too much carbohydrate-containing component (e.g., greater than 40 wt %) can decrease the internal bond strength and thickness swell %.

The aqueous portion can further include a base. The base can typically be present in the binder reaction mixture in a range of from 1 wt % to 33 wt % or 5 wt % to 10 wt % based on a dry weight of the binder reaction mixture. The base can typically be added to such a degree that a pH of the aqueous portion of the binder reaction mixture is greater than 10, for example 10.5, 11, 11.5, 12, 12.5, 13, 13.5, or 14. The pH, therefore, is typically in a range of from 10 to 14 or 10 to 13.5 or 11 to 14. Typically, the base includes NaOH, magnesium oxide, KOH or mixtures thereof. In some aspects the base can include another strong base (for example, Ca(OH)₂ or another base that completely dissociates in solution) or sodium carbonate. In some aspects ammonium or ammonia hydroxide can be used as the base, but these are not preferred because of their propensity to generate gaseous ammonia. In some aspects, the base includes solely NaOH. It was found that using a base to achieve these pH values, in particular, led to improvement in the thickness swell %, modulus of rupture, and modulus of elasticity of the resulting engineered wood.

While not intending to be limited to any theory, it is believed that the base, at the disclosed concentration results in the high pH environment enhances the reaction between the carbohydrate-containing component, polypeptide-containing component, and wood component to form a biopolymer network enveloping the wood component. For example, it is believed that the base can help to dissolve at least a portion of individual wood components. This, in turn, allows the binder precursor solution to penetrate at least partially into the interior of the individual wood component. Therefore, when the binder precursor is subjected to curing a greater degree of interlocking between the binder and the individual wood components can be achieved. While not intending to be bound to any theory, it is believed that this in conjunction with the hydrogen bonds formed between the glycerol or oligomer of glycerol with the polypeptide-containing component, potentially the wood component and where present the carbohydrate-containing component can help to improve the physical properties of the engineered wood. The relatively high pH values described herein, are not described in U.S. Pat. No. 8,501,838.

In certain aspects, the engineered wood precursor mixture can include sodium sulfite, sodium bisulfite, sodium metabisulfite or a mixture thereof. Where present, the sodium sulfite, sodium bisulfite, or a mixture thereof is in a range of from 0.5 wt % to 10 wt % or from 1 wt % to 5 wt %, based on the dry weight of the binder reaction mixture. Including sodium sulfite, sodium bisulfite, or a mixture thereof can help to increase the strength of the resulting engineered wood product. For example, they can help to increase the modulus of rupture, modulus of elasticity, internal bond strength, or a combination thereof of the engineered wood, relative to a corresponding engineered wood that is free of sodium sulfite, sodium bisulfite, sodium metabisulfite, or a mixture thereof. However, in certain aspects, including sodium sulfite, sodium bisulfite, sodium metabisulfite or a mixture thereof such that the amount of polypeptide-containing component in the aqueous portion needs to be reduced, the strength of the engineered wood can be decreased. Where present, a ratio of sodium sulfite to polypeptide-containing component is in a range of from 1:100 to 12:100 or 1:100 to 4:100. The aqueous portion can further include 0.1 wt % to 10 wt % sodium trimetaphosphate based on a dry weight of the binder reaction mixture.

According to various aspects, the aqueous portion can further include a borax. The term borax is often used for a number of closely related minerals or chemical compounds that differ in their crystal water content. Examples of suitable borax compounds include sodium tetraborate decahydrate (or sodium tetraborate octahydrate), sodium tetraborate pentahydrate, anhydrous sodium tetraborate, and mixtures thereof. Where present the borax can be in a range of from 1 wt % to 15 wt % based on the dry weight of the binder reaction mixture or 3 wt % to 6 wt %.

The aqueous portion can further include calcium carbonate. Where present, calcium carbonate can be in a range of from 1 wt % to 15 wt %, based on the dry weight of the binder reaction mixture or 3 wt % to 8 wt %.

The binder reaction mixture further includes an at least partially non-dissolved polypeptide-containing component distributed about the glycerol or oligomer of glycerol, and where present, the carbohydrate-containing component and wood component. The concentration of polypeptide-containing component is measured based on the dry weight of the binder reaction mixture. The concentration of the polypeptide-containing component can typically be in a range of from 20 wt % to 85 wt %, 30 wt % to 80 wt %, or 40 wt % to 65 wt %.

The polypeptide-containing component can typically include a protein sourced from an animal protein, a casein salt, a plant protein, a soy flour, linseed flour, flaxseed flour, cottonseed flour, canola flour, sunflower flour, peanut flour, lupin flour, pea flour, corn protein isolate, and mixtures thereof. In some aspects the polypeptide-containing component includes a protein sourced from soy flour, wheat gluten, corn protein isolate, or a combination thereof.

In some aspects, the polypeptide-containing component includes a protein sourced from soy flour. The soy flour can be from 40 wt % to 65 wt % or 50 wt % to 60 wt % protein based on the total soy flour present. Where the polypeptide-containing component is a mixture such as a flour, it is possible for it to include non-protein constituents such as a carbohydrate. In these instances, the disclosed concentrations of the carbohydrates in the binder precursor, or reaction product thereof, are independent of the amount of carbohydrate present from the polypeptide-containing component. It has been surprisingly and unexpectedly found that mixtures including soy flour produce engineered wood products having better properties than a corresponding engineered wood formed with constituents having higher percentages of protein.

In certain aspects, where the polypeptide-containing component includes soy flour, the soy flour can have a protein dispersibility index of at least 60. For example, a protein dispersibility index of the soy flour can be in a range of from 70 to 95, for example a PDI from 80 to 90. It has been shown that if the soy flour has a higher PDI, the physical properties of the engineered wood product are better than a corresponding engineered wood product differing in that the PDI of the soy flour is lower. If it is desired to screen the polypeptide-containing component by size, the polypeptide-containing component can be selected from one that passes through a screen sized 100-mesh screen to a 635-mesh screen or a 100-mesh screen to a 400-mesh screen, for example a screen size can be from 150 to 325.

The polypeptide-containing component can take the form of a solid (e.g., a powder) or can be in the form of a slurry or suspension (e.g., contains both solid and liquid phases).

As described previously, the binder is substantially free of a urea-formaldehyde. Therefore, the precursors described herein are also free of a urea-formaldehyde. For example, the mixture can typically include less than 5 wt % of urea-formaldehyde or be substantially free of urea-formaldehyde.

The moisture content of the mixture of the binder and the plurality of wood components can be carefully controlled. For example, the moisture content typically is in a range of from 7 wt % to 25 wt %, 7 wt % to 20 wt %, 8 wt % to 15 wt % or in a range of from 10 wt % to 13 wt %, 10 wt % to 14 wt %, 11 wt % to 15 wt %, 11 wt % to 13 wt %, or less than 14 wt %. The moisture content can affect the ability to disperse the components of the mixture about the wood components and the reactivity of the substrates. In instances where the engineered wood product includes multiple layers (e.g., a first face layer, a second face layer, and a core layer) the moisture content of each layer can be substantially the same. The moisture content can be tuned, for example by increasing or decreasing the moisture content in the binder. For example, if the moisture content in the wood is low, the moisture content in the binder can be increased to bring the total moisture content of the mixture of the binder and plurality of wood components to a desired level. In some aspects, moisture can be added to the binder by spraying water to the binder distributed on the wood components. However in certain aspects, water can simply be added to the glycerol or oligomer of glycerol, and where present, the carbohydrate-containing component before it is applied to the wood component. This can give better distribution of the moisture across the mixture of binder and wood components. As used herein a moisture content means the total moisture content (by weight percent) of the mixture of the wood components and binder reaction mixture. This is referred to in the Examples here in as “W_{T}”. Alternatively, the moisture content of the mixture of the wood components and binder reaction mixture is referred to as a “mat moisture”. As a further alternative, the total moisture content of the wood components and the binder reaction mixture is referred to as the “moisture content of the binder reaction mixture that is applied to the plurality of wood components.”

The engineered wood described herein can be made or manufactured according many suitable methods. As an example, a method can include (a) mixing the glycerol component including glycerol or an oligomer of glycerol, water, and the base to produce a first mixture. In some further examples additional components such as sodium sulfite, any carbohydrate-containing component described herein, any borax described herein, or a mixture thereof to produce the first mixture.

After the components are sufficiently mixed, the method can further include (b) mixing the mixture produced at (a) with the plurality of wood components to obtain a second mixture. To help to achieve a uniform blend, mixing at (b) is typically performed by spraying the mixture produced at (a) to the plurality of wood components. The spraying and mixing can typically occur for a time in a range of from 1 minute to 60 minutes or 1 minute to 10 minutes. It was found that increased mixing times resulted in stronger engineered woods. As used herein “mixing” means that the components are combined or added to each other to effect combination. In some examples “mixing” can include spraying at least one component to another component. In some examples “mixing” can include stirring a plurality of the components.

The glycerol or oligomer of glycerol can be in a range of from 5 wt % to 50 wt % or 25 wt % to 40 wt %, or 5 wt % to 65 wt %, 10 wt % to 30 wt %, 20 wt % to 30 wt %, at least 5 wt %, at least 10 wt %, at least 20 wt %, or at least 30 wt %, based on the dry weight of polypeptide-containing component, base, and glycerol or the oligomer of glycerol component and, where present, sodium sulfite, a carbohydrate-containing component, borax, or a mixture thereof. Where present, the carbohydrate-containing component in a range of from 2 wt % to 40 wt % or 2 wt % to 30 wt % or 5 wt % to 20 wt %, based on the dry weight of polypeptide-containing component, base, and glycerol or the oligomer of glycerol component and, where present, sodium sulfite, borax, carbohydrate-containing component, or a mixture thereof. The base can be present at 1 wt % to 33 wt %, based on the dry weight of polypeptide-containing component, base, and glycerol or the oligomer of glycerol component and, where present, sodium sulfite, a carbohydrate-containing component, borax, or a mixture thereof A pH of the first mixture can be greater than 10, for example 10.5, 11, 11.5, 12, 12.5, 13, 13.5, or 14.

After mixing at (b) is performed, the method further includes (c) mixing the mixture produced at (b) with the polypeptide-containing component to form a third mixture. Alternately, the polypeptide containing component can first be combined with the wood particles followed by adding the mixture of (a). The polypeptide-containing component at this stage can be in a powder form. It has been found that the properties of the resulting engineered wood (e.g., modulus of rupture, modulus of elasticity, thickness swell %, internal bond strength, or a combination thereof) are better when the polypeptide-containing component is in powder form as opposed to a dispersion form. The polypeptide component is in a range of from 20 wt % to 80 wt % or 30 wt % to 80 wt %, based on the dry weight of polypeptide-containing component, base, and glycerol or the oligomer of glycerol component and, where present, sodium sulfite, a carbohydrate-containing component, borax, or a mixture thereof. The borax can be in a range of from 1 wt % to 15 wt % or 3% to 6%, based on the dry weight of polypeptide-containing component, base, and glycerol or the oligomer of glycerol component, borax component, and, where present, sodium sulfite, a carbohydrate-containing component, or a mixture thereof. The calcium carbonate is present in a range of from 1 wt % to 15 wt % or 3 wt % to 8 wt %, based on the dry weight of polypeptide-containing component, base, and glycerol or the oligomer of glycerol component, calcium carbonate, and, where present, sodium sulfite, a carbohydrate-containing component, borax, or a mixture thereof.

Before performing step (b), the first mixture obtained at (a) can be used immediately. However, the first mixture obtained at (a) can also show good stability. For example, the first mixture obtained at (a) can be stable for at least 1 hour, or at least 12 hours. Moreover, it is suspected that the mixture obtained at (a) can effectively be used when stored for 26 hours or greater before performing (b), for example, the first mixture can show stability for at least 50 hours, at least 120 hours, at least 360 hours, at least 1400 hours, at least 2000 hours, from 26 hours to 1400 hours, or from 50 hours to 360 hours before performing (c). These times can be reduced by heating the mixture. The step at (c) is typically performed for at least 1 minute, for example in a range of from 1 minute to 60 minutes or from 1 minute to 10 minutes.

Before performing step (d), the third mixture formed during step (c) exhibits tack properties comparable or improved relative to alternative binder systems (e.g., those using a urea-formaldehyde binder). Tack is the adhesive property that imparts upon the materials being bound, the ability to lightly stick together with gentle pressure. Tack is typically an important property for maintaining the shape and distribution of wood fibers within the mattress during initial formation throughout the particleboard manufacturing process. Increasing the carbohydrate-containing component portion of the aqueous portion of the binder reaction mixture during step (b) appears to visually improve the tack properties of the resulting binder reaction mixture. Adding the carbohydrate-containing component can enhance the tack described herein. Although in some examples, it may be desirable to keep the concentration of high fructose corn syrup below 20 wt %, for example, below 15 wt %, below 10 wt %, or below 5 wt %.

After mixing at step (c) is performed, the method further includes (d) curing the third mixture formed at (c) to form the engineered wood. Curing can include (e) hot pressing the binder reaction mixture formed at (d). Hot pressing at (e) is performed typically at a pressure of at least 5 psi and at least 10 psi, at least 50 psi, 100 psi and typically less than 500 psi, or from 30 psi to 400 psi. In addition to the pressure, a platen of the press used for hot pressing at (e) is heated to a temperature in of at least 100° C., for example, at least 120° C., or at least 187° C. in a range of from 100° C. to 250° C., in a range of from 180° C. to 220° C. or in a range of from 120° C. to 190° C. In some examples, the platen is heated to achieve a curing temperature of at least 198° C., at least 204° C., at least 246° C. in a range of from 198° C. to 232° C., 204° C. to 226° C., 210° C. to 221° C., less than 315° C., or preferably less than 230° C. Typically the platen is heated to achieve a curing temperature in a range of from 204° C. to 248° C., 210° C. to 243° C., 210° C. to 226° C., at least 215° C., or at least 251° C. . . . In some examples, the platen is heated to less than 250° C., preferably less than 230° C., less than 220° C., less than 200° C., less than 190, or less than 180° C. The method can further include a “cold pressing” step that can occur before or after the hot pressing. Cold pressing can occur at ambient temperatures.

Curing above 100° C. causes water to convert to steam that creates an internal gas pressure in the product, which can ultimately cause the wood product to fail in maintaining structural soundness (e.g., blow). This problem is especially present if a urea-formaldehyde based binder if is used. Surprisingly and unexpectedly, using the instantly disclosed binders, it is possible to cure the engineered wood products at high temperatures (by heating to platen to a high temperature) and high mat moisture content (both within the respective ranges described herein) without causing the product to blow.

Any of the swell-retardant components described herein can be added to the wood component at any point during the method at step (a), (b), (c), or a combination thereof. Similarly, sodium sulfite, sodium bisulfite, sodium metabisulfite or a mixture thereof can be added to the method at step (a), (b), (c), or a combination thereof. Furthermore, calcium carbonate can be added to the method at step (a), (b), (c), or a combination thereof

It has been found however, that performing at least steps (a), (b), and (c) in sequential order improves the properties in the engineered wood. Specifically, the modulus of rupture, modulus of elasticity, and thickness swell % in the resulting engineered wood are improved as compared to corresponding engineered woods formed in a different order. Without intending to be bound to any theory, it is believed that performing these steps, in order, helps to achieve an even spread of the aqueous portion of the binder reaction mixture and help the aqueous portion to be at least partially embedded into the wood component by virtue of the base creating openings in the wood component. Thus, when the polypeptide-containing component comes into contact with the aqueous portion, the interaction between the two is uniform. It was found that including the polypeptide-containing component along with the wood component, glycerol, base, sulfite or bisulfite salts, borax and carbohydrate-component in one step reduced the thickness swell %, modulus of rupture, and modulus of elasticity of the resulting engineered wood.

### WORKING EXAMPLES

Various aspects of the present disclosure can be better understood by reference to the following Working Examples which are offered by way of illustration. The present disclosure is not limited to the Working Examples given herein. Unless indicated to the contrary, the wood used in the examples had a moisture content of from about six percent by weight (6 wt %) to about nine weight percent (9 wt %); and % NaOH, % Prolia 200/90, % Glycerol, % Na₂SO₃, etc. refer to dry weight percent of the indicated component based on the total dry weight of the binder reaction mixture.

### Materials

| Name | Supplier |
|---|---|
| IsoClear 42% | A high fructose corn syrup, available |
| | from Cargill, Incorporated, Wayzata, |
| | MN. Includes 42 wt % fructose and 52 |
| | wt % glucose and 6% other saccharides |
| Prolia 200/90 | A soy flour having protein content of |
| | 52.5% and a 200 mesh particle size and a |
| (Soy Flour) | polydispersity index (PDI) of 90, |
| | available from Cargill, Incorporated, |
| | Wayzata |
| Gluvital | A wheat gluten having a protein content |
| | of 40%, available from Cargill, |
| | Incorporated, Wayzata, MN |
| UF | A urea-formaldehyde resin (UF) |
| | available under the trade name |
| | WELDWOOD UF, available from DAP, |
| | Baltimore, MD |
| Wood Fiber | Wood Fibers, available under the trade |
| (WF) | designation MINI FLAKE, available |
| | form America's Choice, Columbia, MD |
| | In a multi-layer construction, Wood |
| | Particles having an average aspect ratio |
| | (length:width) of greater than 1:1. Wood |
| | particles used in the face layer typically |
| | have a lower average aspect ratio than |
| | the wood particles used in the core layer. |
| | Additionally, the wood particles used in |
| | the face layer have a smaller average |
| | particle size than the wood particles used |
| | in the core layer |
| Crude Glycerol | A mixture including 15%-20% water, 3- |
| (Crude GLY) | 7% NaCl and 55-95% glycerol, available |
| | from Cargill, Incorporated, Wayzata, |
| | MN |
| USP Glycerol | A greater than 99% glycerol |
| (USP GLY) | composition, available from Cargill, |
| | Incorporated, Wayzata, MN |
| Oxicure 510 | A mixture of 70% glycerol oligomers |
| | and 30% glycerol monomers, available |
| | from Cargill, Incorporated, Wayzata, |
| | MN |
| Oxicure 520 | A mixture of 97.1% glycerol oligomers |
| | and less than 2.9% glycerol monomers, |
| | available from Cargill, Incorporated, |
| | Wayzata, MN |
| Cationic Starch | A cationic (quaternary amine) waxy |
| | cross-linked corn starch |
| Isosorbide | A polyol, available from Cargill, |
| | Incorporated, Wayzata, MN |
| Sorbitol | A polyol, available from EMD |
| | Chemicals, Billerica, MA |
| Erythritol | A polyol, available from NOW Foods, |
| | Bloomingdale, IL |
| Pentaerythritol | A polyol, available from Sigma Aldrich, |
| | St. Louis, MO |
| Inositol 99% | A 99% pure polyol solution, available |
| | from Alfa Aesar, Haverhill, MA |
| Ethylene glycol | Available from Sigma Aldrich, St. Louis, |
| | MO |
| NaOH | A 50% sodium hydroxide solution |
| | available from Thermo Fischer |
| | Scientific, Waltham, MA |
| Na₂SO₃ | Sodium sulfite, available from Acros |
| | Organics, Fair Lawn, NJ |
| Na₂B₄O₇•10H₂O | A sodium tetraborate decahydrate borax, |
| (Borax) | available from Thermo Fischer |
| | Scientific, Waltham, MA |
| Glyoxal | A 40% solution of a dialdehyde |
| | (C₂H₂O₂), available from Alfa Aesar, |
| | Haverhill, MA |
| Calcium | Available from EMD Chemicals, |
| Carbonate | Billerica, MA |
| Urea | Available from EMD Chemicals, |
| | Billerica, MA |
| Sodium | Sodium trimetaphosphate available from |
| trimetaphosphate | ICL Performance Products, LP, Tel |
| (STMP) | Aviv, IL |
| ChemMod 48 | A low viscosity aliphatic triglycidyl |
| | ether, available from Cargill, |
| | Incorporated, Wayzata, MN |
| Ground SF | A soy flour ground to a 100 mesh |
| White Flake | particle size and including a maximum |
| | of 8 wt % moisture, a minimum of 50 |
| | wt % protein, a maximum of 1.2 wt % fat, |
| | a maximum of 3.5 wt % crude fiber, and |
| | a minimum protein dispersibility index |
| | (PDI) of 80, available from Cargill, |
| | Incorporated, Wayzata, MN |
| Prolia 100/90 | A soy flour having protein content of |
| | 50% and a 100 mesh particle size and a |
| | polydispersity index (PDI) of 90, |
| | available from Cargill, Incorporated, |
| | Wayzata |
| Prolia 200/70 | A soy flour having protein content of |
| | 50% and a 200 mesh particle size and a |
| | polydispersity index (PDI) of 70, |
| | available from Cargill, Incorporated, |
| | Wayzata |
| Prolia 200/20 | A soy flour having protein content of |
| | 50% and a 200 mesh particle size and a |
| | polydispersity index (PDI) of 20, |
| | available from Cargill, Incorporated, |
| | Wayzata |

### General Lab Procedures of Particle Board (PB) Binder Preparation

The total moisture content of the glue and wood component (e.g., wood fiber) was set at 12.5%. The moisture of wood fiber (WF) was determined using a Mettler Toledo moisture balance with heating temperature at 110° C. Then the amount of water to be added to aqueous binder solution was calculated according to Equation 1. Typically, the adhesive dose was 13 parts per 100 parts of the dry weight of the WF.

$${W}_{A} = {W}_{T} - {W}_{WF} - {W}_{BF} \qquad Equation 1$$

W_{A}: Water to be added to the aqueous portion of the binder solution
W_{T}: Total moisture of the wood fiber and binder
W_{WF}: Water in wood fiber
W_{BF}: Water in the binder ingredients including water in individual binder ingredients, for example polypeptides, glycerol, NaOH, sodium sulfite, borax and carbohydrates

### Lab Preparation of Particle Board (PB) Adhesive

The dry solid of America's Choice Mini-Flakes wood fiber (WF) was measured using a Mettler Toledo moisture balance at 110° C. 9.37 g DI water, 0.386 g of crystal Na₂SO₃, 2.26 g sodium tetraborate decahydrate and 5.05 g of 87.5% crude glycerol were first mixed followed by adding 2.66 g of 50% NaOH solution. The binder solution with 37.2% dry solid was placed on a shaker for about 5 minutes. 7.10 g Prolia 200-90 protein powder was weighed for use.

The 8.91 g of glycerol (GLY) binder solution above was pipetted to the pre-weighed WF with 76.9 g dry weight using Eppendorf Repeater®. The WF and the added binder were mixed in a KitchenAid mixer for 4 minutes followed by the addition of the Prolia 200/90 soy flour powder. After another 2 minute mixing, the WF was transferred to an aluminum mold to cold press at 215-240 psi and at ambient temperature. The mold was then placed in a hot press with heated press molten at 123° C.-130° C. The WF mixture was pressed at 33.8 psi for 10 minutes. The particle board (PB) was conditioned at ambient temperature and humidity.

The modulus of rupture (MOR) and modulus of elasticity (MOE) of the PB with dimension of 11.89 mm×150 mm×100 mm were measured. An industrial scale process may differ. The procedure uses a custom fixture equipped with rods with 127.3 mm support span to support a test piece of the PB on the ends and includes an anvil (50 mm height×100 mm width) to apply even pressure to the center of the PB. Data is collected and analyzed using an Instron Model #5943 running Blue Hill Software version 3.15.1343 on Windows 7 PC with 1 kN load cell.

Data is obtained by placing the PB in the custom fixture and aligning the anvil 2-3 mm above the PB. The anvil is lowered at 25 mm/min to push down into the center of the PB. When the PB reaches a point that it can no longer take the pressure, it ruptures and the force at this point is recorded to determine the modulus of rupture. The modulus of elasticity was determined using the modulus of rupture data.

The thickness swell % measurement is carried out according to the following laboratory-scale procedure. A commercial-scale procedure may differ. The procedure occurs by determining the initial thickness of the PB using calipers. This can be done by taking the measurement at three locations and computing an average initial thickness. The PB is placed in a 4 L glass beaker and 2.1 to 2.2 L of cold tap water is added to completely submerge the PB. The submerged PB is held for 120 minutes. The PB is then removed, excess water is allowed to drip, and the PB is left to equilibrate for 1 to 2 minutes. The thickness swell % of the PB is then measured at six locations and an average thickness swell % is calculated. The initial thickness is subtracted from the thickness swell % and the resulting difference is divided by the initial thickness with the quotient multiplied by 100 to obtain the thickness swell %.

Measurements of the binder in the PB is in terms of parts dry binder to dry WF. For example, the binder may be present in a ratio of 13 parts per 100 parts of the dry weight of the WF to yield a 13:100 ratio.

The UF (comparative formula) resin was used as a benchmark in these examples. UF powder resin was applied to WF prior to the addition of water. The ratio of added UF resin was 10 parts per 100 parts of the dry weight of WF. The mat moisture including WF and the binder in these examples was 12.5% unless specifically mentioned otherwise.

### Example 1

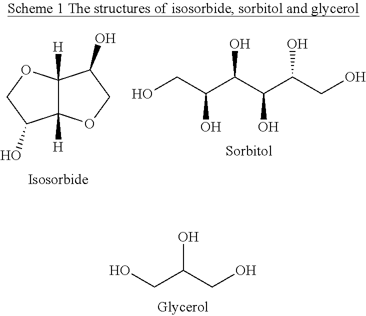

The polyol and fructose binder compositions and results were illustrated in Table 1. PBs prepared with isosorbide and sorbitol had similar or even better dry strength than a particle board prepared with fructose. Among these polyol binders, only the PB including GLY/Prolia 200/90 was weaker than the fructose benchmark. However, it was found that the thickness swell of polyol PBs was all lower than that of the PB prepared with fructose. As used herein, “polyol” does not include saccharide.

According to the polyol structures as shown in Scheme 1, Maillard reactions cannot happen between the polyols and soy flour (e.g., Prolia 200/90) during the curing process because these polyols don't bear any aldehyde or ketone group. However, despite lacking the functional groups that Maillard reaction requires, the PBs prepared with polyol/Prolia 200/90 binder showed good performance in both dry strength and water resistance. Without intending to be bound by any theory, it is believed that the intermolecular hydrogen bonds formed between soy protein and hydroxyl groups of polyols or fructose can play a critical role in the binder network formation.

TABLE 1

| | Formula 1 | Formula 2 | Formula 3 | Formula 4 |
|---|---|---|---|---|
| Parts binder per 100 parts of | 13.1 | 13.0 | 13.0 | 13.1 |
| the dry weight of the WF | | | | |
| Wt % Prolia 200/90 of binder | 54.8% | 55.1% | 55.2% | 55.0% |
| as the polypeptide containing | | | | |
| component in the binder | | | | |
| reaction mixture | | | | |
| Wt % fructose in the binder | 39.2% | | | |
| reaction mixture | | | | |
| Wt % of isoboride as polyol in | — | 38.9% | — | — |
| the binder reaction mixture | | | | |
| Wt % sorbitol as polyol in the | — | — | 38.8% | — |
| binder reaction mixture | | | | |
| Wt % glycerol as polyol in the | — | — | — | 38.9 |
| binder reaction mixture | | | | |
| Wt % NaOH in the binder | 6.0% | 6.0% | 6.0% | 6.1% |
| reaction mixture | | | | |
| MOR, N/mm² | 2.72 | 3.20 | 2.87 | 2.55 |
| MOE, N/mm² | 324 | 245 | 266 | 251 |
| Thickness Swell % | 33% | 28% | 31% | 25% |

### Example 2

To further examine the function of polyols in polyol/Prolia 200/90 binder, erythritol, pentaerythritol and Oxicure 510 were tested on PB. Because pentaerythritol and inositol water solubility are poor, they were only used as additives in fructose/Prolia 200/90 binder as shown in Table 2.

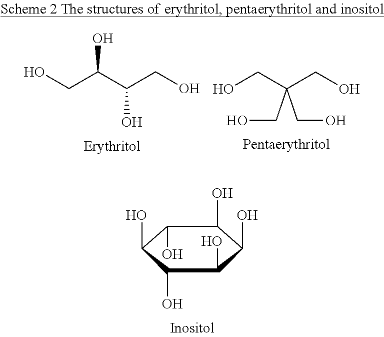

Oxicure 510 contains 70% of GLY oligomers and 30% of GLY monomer. It yielded the PB showing the best dry strength and water resistance. Despite showing that dry strength of these PBs was more or less different, all polyol PBs yielded decent mechanical properties and water resistance. Therefore, the theory of hydrogen bond formation between polyol and soy protein is applicable for most polyol/Prolia 200/90 binders, not being strictly limited by the structures of polyols. Glycerol may be particularly advantageous to include as it is more economically viable that other polyols described herein.

TABLE 2

| | Formula 5 | Formula 6 | Formula 7 | Formula 8 | Formula 9 |
|---|---|---|---|---|---|
| Parts binder per 100 | 13.0 | 13.0 | 13.0 | 13.0 | 13.0% |
| parts of the dry | | | | | |
| weight of the WF | | | | | |
| Wt % Prolia 200/90 of | 55.3% | 55.4% | 55.2% | 55.1% | 55.2% |
| binder as the | | | | | |
| polypeptide | | | | | |
| containing component | | | | | |
| in the binder reaction | | | | | |
| mixture | | | | | |
| Wt % fructose in the | 38.8% | — | — | 19.4% | 34.9 |
| binder reaction | | | | | |
| mixture | | | | | |
| Wt % OC510 as | — | 38.7% | — | — | — |
| polyol other than | | | | | |
| fructose in the binder | | | | | |
| reaction mixture | | | | | |
| Wt % erythritol as | — | — | 38.8% | — | — |
| polyol other than | | | | | |
| fructose in the binder | | | | | |
| mixture | | | | | |
| Wt % inositol as | — | — | — | 19.4% | — |
| polyol other than | | | | | |
| fructose in the binder | | | | | |
| reaction mixture | | | | | |
| Wt % pentaerythritol | — | — | — | — | 3.9 |
| as polyol other than | | | | | |
| fructose in the binder | | | | | |
| reaction mixture | | | | | |
| Wt % NaOH in the | 6.0% | 6.0% | 6.0% | 6.1% | 6.0% |
| binder reaction | | | | | |
| mixture | | | | | |
| MOR, N/mm² | 3.30 | 3.53 | 2.76 | 3.27 | 3.06 |
| MOE, N/mm² | 393 | 399 | 275 | 295 | 355 |
| Thickness Swell % | 34% | 27% | 30% | 34% | 31% |

### Example 3

Oxicure 520 (OC520) is a polyglycerol with a higher molecular weight than OC 510. In the formulations showed in Table 3, glycerol was completely or partially replaced with OC520. The binder with OC520 produced the PB with the best mechanical strength and the one with the mixed glycerol and OC520 came in second place. However, there was no improvement on the MOR and MOE by mixing OC510 with glycerol.

TABLE 3

| | Formula 10 | Formula 11 | Formula 12 | Formula 13 |
|---|---|---|---|---|
| Parts binder per 100 parts | 13.0 | 13.0 | 13.0 | 13.0 |
| of the dry weight of the | | | | |
| WF | | | | |
| Wt % Prolia 200/90 of | 53.6% | 53.7% | 53.7% | 53.7% |
| binder as the polypeptide | | | | |
| containing component in | | | | |
| the binder reaction mixture | | | | |
| Wt % glycerol in the binder | 37.6% | — | 32.6% | 32.6% |
| reaction mixture | | | | |
| Wt % OC520 in the binder | — | 37.6% | 5.0% | — |
| reaction mixture | | | | |
| Wt % OC510 in the binder | — | — | — | 5.0% |
| reaction mixture | | | | |
| Wt % NaOH in the binder | 6.0% | 6.0% | 6.0% | 6.0% |
| reaction mixture | | | | |
| Wt % Na₂SO₃ in the binder | 2.1% | 2.2% | 2.2% | 2.1% |
| reaction mixture | | | | |
| MOR, N/mm² | 2.49 | 3.02 | 2.88 | 2.45 |
| MOE, N/mm² | 297 | 344 | 307 | 290 |
| Thickness Swell % | 25% | 27% | 25% | 24% |

### Example 4

The experimental results provided herein above suggest numerous insights into the interactions between protein and polyols or fructose in the PB curing process. To understand further parameters of the glycerol binders, various binders formulated with glycerol, Prolia 200/90 and NaOH were tested and compared with a fructose/soy flour/NaOH binder, as a comparative formulation, as described further herein. It was decided to use sodium sulfite to improve the dry strength of the glycerol, Prolia 200/90, and NaOH binder. It was suspected that this would help, because sodium sulfite can break the disulfide bonds of soy protein, which in turn can allow the hydrogen bonding to form on the inside of the heated protein. Meanwhile the cleavage of disulfide bond exposes the hydrophobic residues of soy protein to the surface during the unfolding process. These structural changes can lead to the increase in dry strength and water resistance. The glycerol formulation with sodium sulfite is presented in Table 4.

This result demonstrated that the addition of a small amount of Na₂SO₃ can enhance the dry strength of glycerol binder. Relative to the comparison formulation, glycerol is generally cheaper than fructose and it is therefore economically beneficial to make this substitution. Additionally, the PB with GLY exhibited better water resistance than fructose-based PB.

TABLE 4

| | Formula 14 | Formula 15 |
|---|---|---|
| Parts binder per 100 parts | 13.0% | 13.1% |
| of the dry weight of the | | |
| WF | | |
| Wt % Prolia 200/90 of | 54.2% | 54.3% |
| binder as the polypeptide | | |
| containing component in | | |
| the binder reaction | | |
| mixture | | |
| Wt % fructose in the | 38.1% | |
| binder reaction mixture | | |
| Wt % USP glycerol in the | — | 38.0% |
| binder reaction mixture | | |
| Wt % NaOH in the binder | 6.0% | 6.0% |
| reaction mixture | | |
| Wt % Na₂SO₃ in the | 1.8% | 1.6% |
| binder reaction mixture | | |
| MOR, N/mm² | 2.80 | 3.25 |
| MOE, N/mm² | 298 | 303 |
| Thickness Swell % | 33% | 28% |

### Example 5

The different amount of sodium sulfite was added to glycerol binder to optimize the dose of sodium sulfite as shown in Table 5 and 6. The ratio of sodium sulfite to Prolia 200/90 increased from 0:100 to 12:100. The results indicate that the GLY binder without Na₂SO₃ yielded a very low dry strength, consistent with the results recorded in Table 3. The optimum ratio of Na₂SO₃ to Prolia 200/90 was around 1:100-4:100. The further increase in sodium sulfite level brought no further increase in dry strength. Without intending to be bound by any theory, the effect of Na₂SO₃ on binder performance was limited by the number of the disulfide bonds in the soy protein structure.

TABLE 5

| | | Formula | Formula | Formula | Formula | Formula |
|---|---|---|---|---|---|---|
| | UF | 16 | 17 | 18 | 19 | 20 |
| Parts binder per 100 | 10.0 | 13.0 | 13.0 | 13.0 | 13.0 | 13.0 |
| parts of the dry | | | | | | |
| weight of the WF | | | | | | |
| Wt % Prolia 200/90 of | — | 43.3% | 42.5% | 42.2% | 41.7% | 41.2% |
| binder as the | | | | | | |
| polypeptide | | | | | | |
| containing | | | | | | |
| component in the | | | | | | |
| binder reaction | | | | | | |
| mixture | | | | | | |
| Wt % Crude GLY in | — | 50.7% | 49.7% | 49.29% | 48.7% | 47.9% |
| binder reaction | | | | | | |
| mixture | | | | | | |
| Wt % NaOH in the | — | 6.0% | 6.0% | 6.0% | 6.0% | 6.0% |
| binder reaction | | | | | | |
| mixture | | | | | | |
| Wt % Na₂SO₃ in the | — | 0.0% | 1.7% | 2.5% | 3.7% | 4.9% |
| binder reaction | | | | | | |
| mixture | | | | | | |
| MOR, N/mm² | 2.44 | 2.30 | 2.84 | 2.45 | 2.59 | 2.88 |
| MOE, N/mm² | 224 | 260 | 303 | 270 | 268 | 274 |
| Thickness Swell % | 21% | 24% | 23% | 24% | 23% | 25% |

TABLE 6

| | Formula 21 | Formula 22 | Formula 23 | Formula 24 |
|---|---|---|---|---|
| Parts binder per 100 parts of | 13.0 | 13.0 | 13.0 | 13.0 |
| the dry weight of the WF | | | | |
| Wt % Prolia 200/90 of binder | 53.3% | 52.9% | 52.3% | 51.9% |
| as the polypeptide | | | | |
| containing component in the | | | | |
| binder reaction mixture | | | | |
| Wt % Crude GLY in binder | 36.2% | 36.1% | 36.1% | 36.1% |
| reaction mixture | | | | |
| Wt % NaOH in the binder | 10.0% | 10.0% | 10.0% | 10.0% |
| reaction mixture | | | | |
| Wt % Na₂SO₃ in the binder | 0.6% | 1.1% | 1.6% | 2.1% |
| reaction mixture | | | | |
| MOR, N/mm² | 2.60 | 2.65 | 2.59 | 2.40 |
| MOE, N/mm² | 288 | 304 | 302 | 308 |
| Thickness Swell % | 25% | 26% | 25% | 26% |

### Example 6

Different grades of GLY are available including crude GLY, technical GLY, as used herein includes less than 5% water and USP GLY includes less than 10 ppm chloride and less than 0.5% water. Crude glycerol, as used in these Examples, includes 10 to 20 wt % water (for example 15 wt %), 3 wt % to 7 wt % NaCl and 80 wt % to 92 wt % glycerol (for example 87.5 wt %). A crude glycerol may include additional materials known to one of skill in the art. Technical and USP glycerol are industrial and food grade glycerol, respectively which are cleaner, containing less water and salt. For example, technical glycerol typically includes a high concentration of glycerol and less than 1 wt % methanol, less than 0.5 wt % methanol, or less than 0.1 wt % methanol and less than 1 wt % NaCl, less than 0.5 wt % NaCl, or less than 0.1 wt % NaCl.

USP GLY, Crude GLY and Oxicure 510 were formulated with Prolia 200/90, NaOH and Na₂SO₃. UF and Prolia 200/90/fructose/glyoxal/NaOH as benchmarks were tested in the same batch. The ingredient contents of the binders are listed in Table 7. UF resin was 10% of the dry weight of the WF. The other binder doses were 13% of the dry weight of the WF.

Among the binders in this testing, Oxicure 510 binder produced the strongest PB. The PB of crude glycerol has similar dry strength and thickness swell to those of USP glycerol. The significance of replacing USP GLY with crude GLY can relate to the comparatively low price of crude GLY, which can drastically reduce the PB binder cost, making it economically feasible to apply high binder dose to WF to achieve qualified PB properties.

TABLE 7

| | UF | Formula 25 | Formula 26 | Formula 27 | Formula 28 |
|---|---|---|---|---|---|
| Parts binder per 100 parts of | 10.0 | 13.0 | 13.0 | 13.0 | 13.0 |
| the dry weight of the WF | | | | | |
| Wt % Prolia 200/90 of binder | n.a | 53.3% | 42.5% | 42.5% | 42.5% |
| as the polypeptide containing | | | | | |
| component in the binder | | | | | |
| reaction mixture | | | | | |
| Wt % fructose in the binder | — | 37.5% | — | — | — |
| reaction mixture | | | | | |
| Wt % USP glycerol in the | — | — | 49.8% | — | — |
| binder reaction mixture | | | | | |
| Wt % crude glycerol in the | — | — | — | 49.9% | — |
| binder reaction mixture | | | | | |
| Wt % Oxicure 510 in the | — | — | — | — | 49.9% |
| binder reaction mixture | | | | | |
| Wt % NaOH in the binder | — | 6.0% | 6.0% | 6.0% | 6.0% |
| reaction mixture | | | | | |
| Wt % Na₂SO₃ in the binder | — | — | 1.6% | 1.7% | 1.6% |
| reaction mixture | | | | | |
| Wt % glyoxal in the binder | — | 3.2% | — | — | — |
| reaction mixture | | | | | |
| MOR, N/mm² | 2.15 | 2.50 | 2.32 | 2.45 | 2.70 |
| MOR, N/mm² | 221 | 309 | 257 | 254 | 285 |
| Thickness Swell % | 21% | 35% | 24% | 25% | 26% |

### Example 7

Glycerol content in glycerol binder can affect the resulting PB properties. Four different glycerol levels were examined in the formulations listed in Table 8. The dry strength of PBs exhibited an upward trend as the glycerol content level rose from 30% to 60%. The PB water resistance was improved with GLY content. It was also noticed that the dry strength curve showed the inflection point at 60%, where the PB dry strength dropped. The GLY/Prolia 200/90 PBs have greater dry strength compared to that of UF benchmark while the thickness swell is slightly higher.

TABLE 8

| | UF | Formula 29 | Formula 30 | Formula 31 | Formula 32 |
|---|---|---|---|---|---|
| Parts binder per 100 parts of | 10.0 | 13.0 | 13.0 | 13.0 | 13.0 |
| the dry weight of the WF | | | | | |
| Wt % Prolia 200/90 of | — | 62.5% | 54.4% | 42.6% | 32.5% |
| binder as the polypeptide | | | | | |
| containing component in the | | | | | |
| binder reaction mixture | | | | | |
| Wt % Crude GLY in binder | — | 29.9% | 38.0% | 49.7% | 59.8% |
| reaction mixture | | | | | |
| Wt % NaOH in the binder | — | 6.0% | 6.0% | 6.0% | 6.0% |
| reaction mixture | | | | | |
| Wt % Na₂SO₃ in the binder | — | 1.6% | 1.6% | 1.6% | 1.6% |
| reaction mixture | | | | | |
| Ratio of Crude GLY to | — | 48% | 70% | 117% | 184% |
| Prolia 200/90 in the binder | | | | | |
| reaction mixture | | | | | |
| MOR, N/mm² | 2.76 | 3.00 | 3.09 | 3.08 | 2.76 |
| MOE, N/mm² | 227 | 321 | 316 | 315 | 298 |
| Thickness Swell % | 22% | 31% | 29% | 26% | 24% |

### Example 8

The effect of NaOH on PB performance was investigated and the results are presented in Table 9. At 0% and 1% NaOH content level, the dry strength and the water resistance of the PB were similar to those of UF resin but much lower than the PBs with 6% and 12% NaOH. It is clear that NaOH played a positive role in the performance of GLY PB.

TABLE 9

| | UF | Formula 33 | Formula 34 | Formula 35 | Formula 36 |
|---|---|---|---|---|---|
| Parts binder per 100 | 10.0 | 13.0 | 13.0 | 13.0 | 13.0 |
| parts of the dry weight | | | | | |
| of the WF | | | | | |
| Wt % Prolia 200/90 of | — | 57.9% | 57.3% | 54.3% | 50.8% |
| binder as the | | | | | |
| polypeptide containing | | | | | |
| component in the | | | | | |
| binder reaction mixture | | | | | |
| Wt % Crude glycerol in | — | 40.5% | 40.0% | 38.0% | 35.6% |
| binder reaction mixture | | | | | |
| Wt % NaOH in the | — | 0.0% | 1.0% | 6.0% | 12.0% |
| binder reaction mixture | | | | | |
| Wt % Na₂SO₃ in the | — | 1.6% | 1.7% | 1.7% | 1.6% |
| binder reaction mixture | | | | | |
| MOR, N/mm² | 2.53 | 2.50 | 2.49 | 2.77 | 3.09 |
| MOE, N/mm² | 234 | 340 | 327 | 341 | 352 |
| Thickness Swell % | 22% | 33% | 35% | 28% | 29% |

### Example 9

Borax forms borate in aqueous solution. Borate ion can bond with hydroxyl groups as shown below to crosslink soy flour, polyols and carbohydrates. Borax was added to PB binder to increase the dry strength of Prolia 200/90/glycerol binder.

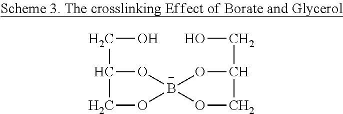 [SMILES: OCC1CO[B-]2(OCC(CO)O2)O1]

2.6-2.7% Borax was applied to GLY binder at 6%, 8% and 10% NaOH levels, respectively as listed in Table 10. The binders with borax showed better MOR and MOE than those without borax at all different NaOH levels. But adding borax showed no effect on the thickness swell of the PBs. Then two different borax levels 2.7% and 5.2% were further examined in GLY binder formulations at 30% and 33% GLY levels, respectively. As presented in Table 11, compared with the formulations having 3% borax, the binders with 6% borax slightly increased the PB MOR and MOE. No significant difference was observed on the thickness swell of these PBs.

TABLE 10

| | Formula | Formula | Formula | Formula | Formula | Formula |
|---|---|---|---|---|---|---|
| | 37 | 38 | 39 | 40 | 41 | 42 |
| Parts binder per 100 | 13.0 | 13.0 | 13.0 | 13.0 | 13.0 | 13.0 |
| parts of the dry | | | | | | |
| weight of the WF | | | | | | |
| Wt % Prolia 200/90 of | 53.2% | 55.2% | 57.2% | 53.3% | 55.2% | 57.1% |
| binder as the | | | | | | |
| polypeptide | | | | | | |
| containing | | | | | | |
| component in the | | | | | | |
| binder reaction | | | | | | |
| mixture | | | | | | |
| Wt % Crude glycerol | 35.4% | 35.4% | 35.4% | 32.9% | 32.7% | 32.8% |
| in binder reaction | | | | | | |
| mixture | | | | | | |
| Wt % NaOH in the | 10.0% | 8.0% | 6.0% | 10.0% | 8.0% | 6.0% |
| binder reaction | | | | | | |
| mixture | | | | | | |
| Wt % Na₂SO₃ in the | 1.4% | 1.4% | 1.4% | 1.3% | 1.4% | 1.4% |
| binder reaction | | | | | | |
| mixture | | | | | | |
| Wt % Na₂B₄O₇ in the | — | — | — | 2.6% | 2.6% | 2.7% |
| binder reaction | | | | | | |
| mixture | | | | | | |
| MOR, N/mm² | 2.37 | 2.46 | 2.66 | 2.84 | 2.84 | 2.95 |
| MOE, N/mm² | 283 | 280 | 301 | 320 | 328 | 347 |
| Thickness Swell % | 25% | 25% | 26% | 25% | 26% | 26% |

TABLE 11

| | Formula 43 | Formula 44 | Formula 45 | Formula 46 |
|---|---|---|---|---|
| Parts binder per 100 parts of | 13.03 | 13.0 | 13.0 | 13.0 |
| the dry weight of the WF | | | | |
| Wt % Prolia 200/90 of | 59.82% | 57.4% | 57.1% | 54.4% |
| binder as the polypeptide | | | | |
| containing component in the | | | | |
| binder reaction mixture | | | | |
| Wt % Crude glycerol in | 29.93% | 30.0% | 32.8% | 32.9% |
| binder reaction mixture | | | | |
| Wt % NaOH in the binder | 6.047% | 6.0% | 6.0% | 6.1% |
| reaction mixture | | | | |
| Wt % Na₂SO₃ in the binder | 1.507% | 1.4% | 1.4% | 1.4% |
| reaction mixture | | | | |
| Wt % Na₂B₄O₇ in the binder | 2.7% | 5.2% | 2.7% | 5.2% |
| reaction mixture | | | | |
| MOR, N/mm² | 2.22 | 2.56 | 2.42 | 2.51 |
| MOE, N/mm² | 276 | 308 | 296 | 311 |
| Thickness Swell % | 26% | 26% | 25% | 24% |

### Example 10

It was noticed that Fructose PB had greater MOE than that of polyol PBs. An investigation of the effect of fructose on crude GLY binder mechanical properties was carried out by replacing a part of glycerol with fructose while the Prolia 200/90, NaOH and Na₂SO₃ contents remained same. Both crude GYL/Prolia 200/90/NaOH/Na₂SO₃ and Fruc/Prolia 200/90/NaOH/Na₂SO₃ binders were employed as benchmarks. In two GLY formulations, 5% and 15% fructose were added to the binder to substitute for the same amount of crude GLY, respectively, as listed in Table 12. The resultant PBs were conditioned at 24° C. and 50% relative humidity (RH) for 5 days. The PBs with 5% and 15% fructose outperformed the two benchmark PBs. In comparison of the formulation with 15% fructose, the binder with 5% fructose resulted in higher PB dry strength at 50% RH. It indicates that the addition of a small amount of fructose (<15%) to GLY/Prolia 200/90 binder can mitigate the PB dry strength loss at high RH environment.

TABLE 12

| | Formula 47 | Formula 48 | Formula 49 | Formula 50 |
|---|---|---|---|---|
| Parts binder per 100 | 13.0 | 13.0 | 13.0 | 13.0 |
| parts of the dry weight | | | | |
| of the WF | | | | |
| Wt % Prolia 200/90 of | 42.4% | 42.5% | 42.5% | 42.4% |
| binder as the | | | | |
| polypeptide containing | | | | |
| component in the | | | | |
| binder reaction mixture | | | | |
| Wt % Crude GLY in | 49.8% | — | 44.8% | 34.9% |
| binder reaction mixture | | | | |
| Wt % NaOH in the | 6.1% | 6.02% | 6.02% | 6.0% |
| binder reaction mixture | | | | |
| Wt % Na₂SO₃ in the | 1.69% | 1.70% | 1.70% | 1.7% |
| binder reaction mixture | | | | |
| Wt % Fructose in the | n.a | 49.8% | 5.0% | 15.0% |
| binder reaction mixture | | | | |
| MOR, N/mm² | 2.25 | 2.34 | 2.68 | 2.5 |
| MOE, N/mm² | 253 | 269 | 285 | 259 |
| Thickness Swell % | 23% | 32% | 25% | 26% |

### Example 11

CaCO₃ and cationic starch were formulated with GLY as additives to improve the dry strength of GLY PB. As shown in Table 13, 6% CaCO₃ can be added either to the aqueous GLY solution or to dry Prolia 200/90. 5% cationic starch was mixed with dry Prolia 200/90 before being sprayed on WF. In comparison with the benchmark GLY binder, both CaCO₃ and cationic starch slightly enhanced the MOR and MOE of the resulting PBs.

TABLE 13

| | Formula 51 | Formula 52 | Formula 53 |
|---|---|---|---|
| Parts binder per 100 parts of | 13.0 | 13.0 | 13.0 |
| the dry weight of the WF | | | |
| Wt % Prolia 200/90 of binder | 59.8% | 60.1% | 59.8% |
| as the polypeptide containing | | | |
| component in the binder | | | |
| reaction mixture | | | |
| Wt % Crude GLY in binder | 29.9% | 23.9% | 25.0% |
| reaction mixture | | | |
| Wt % NaOH in the binder | 6.0% | 6.0% | 5.9% |
| reaction mixture | | | |
| Wt % Na₂SO₃ in the binder | 1.6% | 1.5% | 1.5% |
| reaction mixture | | | |
| Wt % Na₂B₄O₇ in the binder | 2.7% | 2.5% | 2.7% |
| reaction mixture | | | |
| Wt % CaCO₃ in the binder | — | 6.1% | — |
| reaction mixture | | | |
| Wt % cationic starch in the | — | — | 5.0% |
| binder reaction mixture | | | |
| MOR, N/mm² | 1.94 | 2.28 | 2.33 |
| MOE, N/mm² | 247 | 258 | 261 |
| Thickness Swell % | 26% | 27% | 27% |

### Example 12

Urea is commonly used as a denaturant of protein. For comparison purposes, urea and Na₂SO₃ were applied to fructose and glycerol binders, respectively. The compositions of these binders are shown in Table 14. According to the results, the mechanical properties and water resistance of the PB produced by GLY binder with Na₂SO₃ was superior to the one with urea. The same cannot, however, be said for fructose/Prolia 200/90 binder where urea and Na₂SO₃ gave the similar results in terms of MOR and water resistance.

Urea was also added to GLY/Prolia 200/90/Na₂SO₃ binder to replace part of glycerol seen in Table 15. Even though there was sodium sulfite in the binders, the PB with urea showed lower dry strength and higher thickness swell. This suggested that urea as a protein denaturant is not suitable for GLY/Prolia 200/90 PB binder.

TABLE 14

| | Formula | Formula | Formula | Formula |
|---|---|---|---|---|
| | 54 | 55 | 56 | 57 |
| Parts binder per 100 parts of | 13.1% | 13.0% | 13.0% | 13.0% |
| the dry weight of the WF | | | | |
| Wt % Prolia 200/90 of | 54.3% | 53.0% | 54.2% | 53.1% |
| binder as the polypeptide | | | | |
| containing component in the | | | | |
| binder reaction mixture | | | | |
| Wt % Fructose of binder as | — | — | 38.1% | 37.2% |
| the polyol | | | | |
| Wt % USP Glycerol of | 38.0% | 37.3% | — | — |
| binder as the polyol | | | | |
| Wt % NaOH in the binder | 6.0% | 3.0% | 6.0% | 3.0% |
| reaction mixture | | | | |
| Wt % Na₂SO₃ in the binder | 1.6% | — | 1.8% | — |
| reaction mixture | | | | |
| Wt % Urea in the binder | — | 6.7% | — | 6.8% |
| reaction mixture | | | | |
| MOR, N/mm² | 3.25 | 2.50 | 2.80 | 2.97 |
| MOE, N/mm² | 303 | 249 | 298 | 268 |
| Thickness Swell % | 28% | 33% | 33% | 33% |

TABLE 15

| | Formula 58 | Formula 59 | Formula 60 |
|---|---|---|---|
| Parts binder per 100 | 13.0 | 13.01 | 13.0 |
| parts of the dry weight | | | |
| of the WF | | | |
| Wt % Prolia 200/90 of | 42.5% | 42.5% | 42.5% |
| binder as the | | | |
| polypeptide containing | | | |
| component in the | | | |
| binder reaction mixture | | | |
| Wt % Crude GLY in | 49.8% | 44.6% | 29.8% |
| binder reaction mixture | | | |
| Wt % NaOH in the | 6.0% | 6.10% | 6.0% |
| binder reaction mixture | | | |
| Wt % Na₂SO₃ in the | 1.73% | 1.73% | 1.7% |
| binder reaction mixture | | | |
| Wt % Urea in the binder | — | 5.00% | 19.9% |
| reaction mixture | | | |
| MOR, N/mm² | 2.61 | 2.43 | 2.2 |
| MOE, N/mm² | 295 | 277 | 260 |
| Thickness Swell % | 24% | 27% | 33% |

### Example 13

A wheat gluten product called Gluvital 21020 containing 80% protein was examined to see if it could be a suitable addition to the binder. The composition and results of the glycerol/Gluvital binder are given in Table 16. The binder of Gluvital yielded a PB with decent dry strength, though the thickness swell of Gluvital PB was higher than Prolia 200/90 PB. Gluvital may stand a chance to be applied in GLY binder if the dry strength can be further boosted.

TABLE 16

| | UF | Formula 61 | Formula 62 |
|---|---|---|---|
| Parts binder per 100 parts of | 10.0 | 13.0 | 13.0 |
| the dry weight of the WF | | | |
| Wt % Prolia 200/90 of binder | — | 42.5% | — |
| as the polypeptide containing | | | |
| component in the binder | | | |
| reaction mixture | | | |
| Wt % Gluvital wheat gluten | — | — | 42.6% |
| of binder as the polypeptide | | | |
| containing component in the | | | |
| binder reaction mixture | | | |
| Wt % Crude GLY in binder | — | 49.7% | 49.7% |
| reaction mixture | | | |
| Wt % NaOH in the binder | — | 6.0% | 6.0% |
| reaction mixture | | | |
| Wt % Na₂SO₃ in the binder | — | 1.7% | 1.7% |
| reaction mixture | | | |
| MOR, N/mm² | 2.35 | 2.62 | 2.48 |
| MOE, N/mm² | 220 | 253 | 228 |
| Thickness Swell % | 18% | 22% | 28% |

### Example 14

At 12% mat moisture, the GLY binders at three different dose levels 13:100, 11.5:100, and 10:100 were applied to prepare PBs. 10:100 UF dry powder resin and 13:100 fructose binder were used as benchmarks. As shown in Table 17, GLY binder at 13% dose displayed better performance than both UF and Fruc/Prolia 200/90/NaOH/Na₂SO₃ binders. However, when the GLY/Prolia 200/90 binder doses were at 11.5% and 10%, the resulting PBs were inferior to both UF and fructose PBs in terms of modulus of rupture.

TABLE 17

| | UF 10% | Formula 63 | Formula 64 | Formula 65 | Formula 66 |
|---|---|---|---|---|---|
| Parts binder per 100 | 10 | 13.0 | 13.0 | 11.5 | 10.0 |
| parts of the dry weight | | | | | |
| of the WF | | | | | |
| Wt % Prolia 200/90 of | — | 54.2% | 54.2% | 54.3% | 54.3% |
| binder as the | | | | | |
| polypeptide containing | | | | | |
| component in the binder | | | | | |
| reaction mixture | | | | | |
| Wt % USP GLY in | — | — | 38.0% | 38.1% | 38.0% |
| binder reaction mixture | | | | | |
| Wt % Fruct in binder | — | 38.2% | — | — | — |
| reaction mixture | | | | | |
| Wt % NaOH in the | — | 6.0% | 6.0% | 6.0% | 6.0% |
| binder reaction mixture | | | | | |
| Wt % Na₂SO₃ in the | — | 1.6% | 1.7% | 1.7% | 1.7% |
| binder reaction mixture | | | | | |
| MOR, N/mm² | 2.63 | 2.94 | 3.34 | 2.57 | 2.26 |
| MOE, N/mm² | 255 | 415 | 372 | 291 | 264 |
| Thickness Swell % | 22% | 36% | 30% | 32% | 35% |

### Example 15

Different mat moistures were examined in the curing of GLY PB. The GLY binder composition and results at three mat moisture levels were presented in Table 18. The dry strength of GLY PBs decreased with mat moisture. Compared to UF resin, GLY binder cured at 12.5% mat moisture generated a better PB in terms of dry strength and water resistance.

TABLE 18

| | | Formula | Formula | Formula |
|---|---|---|---|---|
| | | 67 | 68 | 69 |
| | UF Mat | With Mat | with Mat | with Mat |
| | Moisture | Moisture | Moisture | Moisture |
| | 12.5% | 12.5% | 11.5% | 10.5% |
| Parts binder per 100 | 10 | 13 | 13 | 13 |
| parts of the dry weight | | | | |
| of the WF | | | | |
| Wt % Prolia 200/90 of | n.a | 42.9% | 43.0% | 42.9% |
| binder as the | | | | |
| polypeptide containing | | | | |
| component in the | | | | |
| binder reaction mixture | | | | |
| Wt % Crude glycerol in | n.a | 49.7% | 49.7% | 49.8% |
| binder reaction mixture | | | | |
| Wt % NaOH in the | n.a | 6.0% | 6.0% | 5.9% |
| binder reaction mixture | | | | |
| Wt % Na₂SO₃ in the | n.a | 1.28% | 1.28% | 1.31% |
| binder reaction mixture | | | | |
| MOR, N/mm² | 2.35 | 2.52 | 2.30 | 2.11 |
| MOE, N/mm² | 220 | 284 | 263 | 219 |
| Thickness Swell % | 18% | 22% | 24% | 23% |

### Industrial Scale Working Examples

As used herein “industrial scale” refers to a protocol conducted at a larger scale than a lab, bench or batch protocol, ways of making a protocol suitable for industry would be understood by one of ordinary skill in the art.

A wood chip moisture was determined by Mettler Toledo moisture balance with heating temperature at 110° C. The solid constituents were dissolved in a pre-weighed amount of water (W_{A}) prior to the addition of crude glycerol and 50% NaOH. Other constituents identified in the respective formulations were added to form an aqueous portion of the binder reaction mixture. After completing the addition all constituents, the aqueous portion of the binder reaction mixture is mechanically agitated for 5 minutes.

The aqueous portion described above is sprayed to the wood chips used to create the particle board (PB) with density 0.67 g/cm³ and mixed for 5 minutes to allow for sufficient dispersion. The wood chips have a heterogenous distribution of sizes and shapes. This is followed by the addition of the polypeptide-containing component in a powder form. The mixture of the wood chips and the binder (aqueous portion and polypeptide-containing component) was then blended for 2 minutes. This process is repeated as needed.

A 91.4 cm×91.4 cm Nordberg hot press utilizing a Pressman control system was set at a temperature of 135° C. to 246° C. to maintain working conditions in a range of from 130° C. to 235° C. The combination of the binder reaction mixture and the wood chips described above is uniformly mixed for 2-10 minutes within a Littleford horizontal continuous mixer, available from B&P Littleford, Saginaw, MI, or equivalent apparatus. The combined wood chip and binder called a resinated furnish, was then transferred into at forming box which was placed on top of a release paper lined caul plate situated on a portable table. The resinated furnish was then evenly distributed across the bottom of the forming box and caul plate to the desired thickness. A 76.2 cm×76.2 cm metal collar frame was then placed evenly inside the forming box and on top of the furnish. A metal cover was then placed into the forming box and used to gently push the collar and WF together to create a mat that will be pressed. The forming box was then lifted off the bottom caul plate, leaving the furnish and cover standing alone.

The metal cover was carefully removed and a second release paper liner was placed on top of the mat, followed by a second caul plate. The entire assembly of the two caul plates with the mat sandwiched between them was then transferred into the hot press. A temperature and pressure probe was inserted into the center of the mat to monitor internal conditions throughout the pressing cycle. The press platens were then slowly closed to a predetermined distance necessary to maintain a particle board thickness of in a range of from 1.80 cm to 2.16 cm with 1.91 cm being the desired measurement. The mat was held for a time in a range of from 30 seconds to 600 seconds and then bottom platen was slowly lowered within 240) seconds to release pressure in the particle board. The time that the mat is held is referred to as a soak time, which accounts for the heating time from the point that the platen reaches the target panel thickness to the time when platen is lifted. The caul plates and finished particle board were then transferred back onto the movable table. Removing the top caul plate reveals the particle board which was then placed into a cooling rack. The particle board was removed and allowed to condition at the proper requirements for testing. After conditioning, the particle board was tested for various properties including Modulus of Rupture (MOR), Modulus of Elasticity (MOE), Thickness Swell %, and Internal Bond Strength (IB).

The modulus of rupture, modulus of elasticity, thickness swell %, and internal bond strength were determined using modified ASTM D 1037-06a. ASTM D 1037-06a was modified in that the test specimens used were conditioned under 50% relative humidity and at 21.1° C. (70° F.). For each of the particle boards, the modulus of rupture, modulus of elasticity, thickness swell %, and internal bond strength were determined by taking the respective particle boards, each having dimensions of 91.44 cm wide×91.44 cm long with a thickness of 1.8 cm to 2.16 cm and ultimately generating one or more test specimens from the particle board. Creating the test specimens included cutting down the particle boards to create a sample particle board. The sample particle board was cut to have dimensions of 76.20 cm wide×76.20 cm long with a thickness of 2.08 cm. To determine the modulus of rupture, modulus of elasticity, thickness swell %, and internal bond strength, several test specimens were created from the sample particle board. Creating several test specimens is helpful to account for the properties of the particle board at different orientations and locations (including edge effect).

To determine the modulus of rupture and modulus of elasticity, 9 test specimens each having dimensions of 50.80 cm long (with a span length of 45.72 cm)×7.62 cm wide with a thickness of 2.08 cm were created from sample particle boards. The modulus of rupture and modulus of elasticity for each test specimen was collected and those values were averaged to yield the modulus of rupture and modulus of elasticity of the particle board. To determine the internal bond strength, 21 test specimens each having dimensions of 5.08 cm long×5.08 cm wide with a thickness of 2.08 cm were created from sample particle boards. The internal bond strength for each test specimen was collected and those values were averaged to yield the internal bond strength of the particle board. To determine the thickness swell %, 3 test specimens each having dimensions of 15.24 cm long×15.24 cm wide with a thickness of 2.08 cm were created from particle wood boards. The internal bond strength for each test specimen was collected and those values were averaged to yield the thickness swell % of the particle board.

### Example 16

The effect of high fructose corn syrup in the binder reaction mixtures was studied. It was found that in at least some examples, high fructose corn syrup levels of 20 wt % or greater negatively impacted the properties of the resulting particle boards. Based upon these results, it is also concluded that borax and STMP are important functional ingredients of glycerol binders. Formulations and results are shown in Table 19. The pressing temperature was 188° C.

TABLE 19

| | Formula 70 | Formula 71 | Formula 72 | Formula 73 |
|---|---|---|---|---|
| Parts binder per | 13 | 13 | 13 | 13 |
| 100 parts of the | | | | |
| dry weight of | | | | |
| the wood chips | | | | |
| Mat Moisture | 10.5% | 10.5% | 10.5% | 10.5% |
| Wt % Prolia | 66.8% | 44.6% | 49.5% | 48.5% |
| 200/90 of | | | | |
| binder as the | | | | |
| polypeptide | | | | |
| containing | | | | |
| component in | | | | |
| the binder | | | | |
| reaction | | | | |
| mixture | | | | |
| Wt % Crude | 20% | 20.0% | 20.0% | 20.0% |
| GLY in binder | | | | |
| reaction | | | | |
| mixture | | | | |
| Wt % NaOH in | 6% | 9.0% | 9.0% | 9.0% |
| the binder | | | | |
| reaction | | | | |
| mixture | | | | |
| Wt % Na₂SO₃ | 2% | 1.34% | 1.49% | 1.46% |
| in the binder | | | | |
| reaction | | | | |
| mixture | | | | |
| Wt % Na₂B₄O₇ | 5.21% | 5.08% | — | — |
| in the binder | | | | |
| reaction | | | | |
| mixture | | | | |
| Wt % STMP in | — | — | — | 1.0% |
| the binder | | | | |
| reaction | | | | |
| mixture | | | | |
| Wt % IsoClear | — | 20% | 20.0% | 20.0% |
| 42 in the binder | | | | |
| reaction | | | | |
| mixture | | | | |
| Soak | 180 | 180 | 180 | 180 |
| Time (s) | | | | |
| IB PSI | 66 | 50 | 43 | 53 |
| MOE kPSI | 343 | 278 | 259 | 243 |
| MOR PSI | 1765 | 1155 | 1225 | 1178 |
| Thickness | 31% | 7% | 23% | 18% |
| Swell % (24 hr) | | | | |

### Example 17

Particle boards obtained using binder formulas 75-78 were formed as described above with a pressing temperature of 154.4° C. with a soak time of 193 seconds. PB mechanical strength was affected by the glycerol content. The formulations and results are shown in Table 20.

TABLE 20

| | Formula 75 | Formula 76 | Formula 77 | Formula 78 |
|---|---|---|---|---|
| Parts binder per 100 parts of the | 13 | 13 | 13 | 13 |
| dry weight of the wood chips | | | | |
| Mat Moisture | 13% | 13% | 13% | 13% |
| Wt % Prolia 200/90 of binder as | 67.2% | 57.4% | 52.5% | 57.4% |
| the polypeptide containing | | | | |
| component in the binder | | | | |
| reaction mixture | | | | |
| Wt % Crude GLY in binder | 20.0% | 29.9% | 35.0% | 30.0% |
| reaction mixture | | | | |
| Wt % NaOH in the binder | 6.0% | 6.0% | 6.0% | 6.0% |
| reaction mixture | | | | |
| Wt % Na₂SO₃ in the binder | 1.7% | 1.4% | 1.3% | 1.4% |
| reaction mixture | | | | |
| Wt % Na₂B₄O₇ in the binder | 5.2% | 5.2% | 5.2% | — |
| reaction mixture | | | | |
| ChemMod 48 in the binder | — | — | — | 5.2% |
| reaction mixture | | | | |
| Internal Bond Strength (PSI) | 72 | 64 | 67 | 44 |
| MOR (PSI) | 1181 | 1020 | 929 | 801 |
| MOE (kPSI) | 242 | 233 | 208 | 183 |
| Thickness Swell % (24 hr) | 26% | 21% | 23% | 27 |

### Example 18

The effect of binder dose in various particle board constructions was studied. Particle boards obtained using binder formulas 79-81 were produced according to the industrial scale described above with a soak time of 180 seconds at 187.7° C. The boards had a thickness of 1.90 cm, a length of 86.36 cm, and a width of 86.36 cm. Formulations and results are shown in Table 21.

TABLE 21

| | Formula 79 | Formula 80 | Formula 81 |
|---|---|---|---|
| Parts binder per | 13 | 10 | 8 |
| 100 parts of the | | | |
| dry weight of the | | | |
| wood chips | | | |
| Mat Moisture | 10.5% | 10.5% | 10.5% |
| Wt % Prolia 200/90 | 66.8% | 66.8% | 66.8% |
| of binder as the | | | |
| polypeptide | | | |
| containing | | | |
| component in the | | | |
| binder reaction | | | |
| mixture | | | |
| Wt % Crude GLY | 20% | 20% | 20% |
| in binder reaction | | | |
| mixture | | | |
| Wt % NaOH in the | 6% | 6% | 6% |
| binder reaction | | | |
| mixture | | | |
| Wt % Na₂SO₃ in | 2% | 2% | 2% |
| the binder reaction | | | |
| mixture | | | |
| Wt % Na₂B₄O₇ in | 5.21% | 5.21% | 5.21% |
| the binder reaction | | | |
| mixture | | | |
| MOE kPSI | 343 | 320 | 298 |
| MOR PSI | 1765 | 1475 | 1225 |
| Thickness Swell % | 31% | 31% | 40% |
| (24 hr) | | | |

### Example 19

The effect of the soak time studied. Particle boards obtained using binder formulas 82-85 were produced according to the methods described above with a soak time indicated in Table 22 at 187.7° C. The boards had a thickness of 1.90 cm, a length of 86.36 cm, and a width of 86.36 cm. Formulations and results are shown in Table 22.

TABLE 22

| | Formula 82 | Formula 83 | Formula 84 | Formula 85 |
|---|---|---|---|---|
| Parts binder per | 13 | 13 | 13 | 13 |
| 100 parts of the | | | | |
| dry weight of | | | | |
| the wood chips | | | | |
| Mat Moisture | 11% | 11% | 10.5% | 10.5% |
| Wt % Prolia | 66.79% | 66.79% | 66.79% | 66.79% |
| 200/90 of | | | | |
| binder as the | | | | |
| polypeptide | | | | |
| containing | | | | |
| component in | | | | |
| the binder | | | | |
| reaction mixture | | | | |
| Wt % Crude | 20% | 20% | 20% | 20% |
| GLY in binder | | | | |
| reaction mixture | | | | |
| Wt % NaOH in | 2% | 2% | 2% | 2% |
| the binder | | | | |
| reaction mixture | | | | |
| Wt % Na₂SO₃ in | 2% | 2% | 2% | 2% |
| the binder | | | | |
| reaction mixture | | | | |
| Wt % Na₂B₄O₇ | 5.21% | 5.21% | 5.21% | 5.21% |
| in the binder | | | | |
| reaction mixture | | | | |
| Soak Time (s) | 102 | 107 | 150 | 180 |
| MOE kPSI | 317 | 293 | 294 | 343 |
| MOR PSI | 1528 | 1362 | 1444 | 1765 |
| Thickness | 32% | 33% | 31% | 31% |
| Swell % (24 hr) | | | | |

### Example 20

A pre-weighed amount of water (W_{A}) and optional components such as Na₂SO₃ are mixed until Na₂SO₃ is dissolved. Then GLY and a polyol component, where present, such as an IsoClear 42% high fructose corn syrup solution and optional components such as borax, are added to the sulfite solution along to form a mixture. 50% alkaline solution such as an NaOH solution is slowly added to the mixture. The formed mixture is agitated until borax is dissolved. The aqueous solution is allowed to cool down to 25-30° C.

With respect to the W_{A}, the total water content of the binder and wood particle (WP) is targeted at a predetermined value. The ratio of the dry binder to dry wood particle is a preterminal value (e.g., 13 parts per 100 parts of dry WP). The water content to be added to the aqueous portion of the binder reaction mixture is calculated based on the third mixture moisture content, the wood particle moisture and total binder moisture content.

The moisture content of wood particle and polypeptide are measured by a Mettler Toledo moisture balance at 110° C. W_{A} is determined according to Equation 1:

$${W}_{A} = {W}_{T} - {W}_{WP} - {W}_{BF} \qquad ( Equation 1 )$$

W_{A}: Water to be added to the aqueous portion of the binder reaction mixture
W_{T}: Total moisture of the third mixture
W_{WP}: Water in wood particle
W_{BF}: Water in the binder ingredients including water in polyol component, NaOH, optional borax, optional IsoClear 42, optional MgO, optional, Na₂SO₃, and Prolia 200/90

According to protocol 2A, water, GLY, NaOH, and optional polyol component (e.g., fructose), optional Na₂SO₃, and/or optional borax is blended and sprayed to the wood particles (WP) and mixed for 5 minutes to allow for sufficient dispersion. Where present, water Na₂SO₃, are mixed first followed by glycerol, IsoClear 42 (where present) and optional borax, followed by NaOH. This is followed by the addition of the polypeptide-containing component (and MgO, if added) (Resin 2) in a powder form and that mixture is then blended for 2 minutes.

Alternatively, according to protocol 2B, the polypeptide-containing component (and MgO, if added) (Resin 2) initially includes the wood particle is blended for 0.2-1 minutes. This is followed by blending the GLY, NaOH, and/or optional polyol component (e.g., fructose), optional Na₂SO₃, and optional borax. Where present, water and Na₂SO₃ are mixed first followed by glycerol, IsoClear 42 (where present) and optional borax, followed by NaOH. This mixture is then sprayed to the wood particles, which is pretreated with Resin 2 and mixed for 0.2-1 minute to allow for sufficient dispersion. The two mixtures are then blended for 2 minutes. Either protocol forms a resinated furnish, which can be pressed and cured.

### Curing Formulas 86-107

A 91.4 cm×91.4 cm Nordberg hot press utilizing a Pressman control system is set to maintain working conditions in a range of from 150-221° C., as indicated in the tables below: The combination of the binder and the wood particle (resonated furnish) described above is uniformly mixed for 2-10 minutes or 5-10 minutes within a Littleford horizontal continuous mixer, available from B&P Littleford, Saginaw, MI, or equivalent apparatus. The face furnishes are then transferred into at forming box, which is placed on top of a release paper lined caul plate situated on a portable table. The furnish is then evenly distributed across the bottom of the forming box. The same procedure is repeated to form a core layer and the second face layer. The mat of the three-layer furnish is then evenly formed in the forming box to the desired thickness. A 76.2 cm×76.2 cm metal collar frame is then placed evenly inside the forming box and on top of the mat. A metal cover is then placed into the forming box and used to gently push the collar and wood particle together to create a mat that will be pressed. The forming box is then lifted off the bottom caul plate, leaving the mat and cover standing alone. The metal cover is carefully removed and a second release paper liner placed on top of the mat, followed by a second caul plate. The entire assembly of the two caul plates with the mat sandwiched between them is then transferred into the hot press.

A temperature and pressure probe is inserted into the center of the mat to monitor internal conditions throughout the pressing cycle. The press platens are then slowly closed to a predetermined distance necessary to maintain a particle board thickness of in a range of from 1.8 cm to 2.16 cm with 1.91 cm being the desired measurement. The mat is held for a time (e.g., a “soak time”) in a range of from 30 to 600 seconds or 145 to 245 seconds or 90 to 130 seconds and then bottom platen is slowly lowered within 240 seconds or 30 seconds to release pressure in the particle board. The caul plates and finished particle board are then transferred back onto the movable table. Removing the top caul plate reveals the multi-layered engineered particle board, which is then placed into a cooling rack. The multi-layer engineered particle board is removed and allowed to condition at the proper requirements for testing. After conditioning, the multi-layer engineered particle board is tested for its Internal Bond Strength (IB).

Binder reaction mixture formulations (Formulas) are provided in Table 23. Each of the engineered wood products included two face layers with a core layer located therebetween—each layer is formed from the respective Formula. The face layers each account for 20 wt % of the total dry weight basis of the respective board before curing. The core layer accounts for 60 wt % of the total dry weight basis of the respective board before curing. In each engineered wood product, the compositions and the moisture content of the face layers and core layer are the same (e.g., use the same identified Formula), with the expectation that the wood particles of the face layers have a smaller average particle size than the wood particles of the core layer. The overall density of the engineered wood product is 0.673 g/cm³. However, smaller wood particles in the face layers result in the face layers having a higher density than the core layer.

Curing of formulas 108-113 was carried out in accordance with the procedures described above title “Lab preparation of particle board (PB) adhesive.” The engineered wood products produced form formulas 108-113 were single-layer products.

TABLE 23

| | | | | | | | Ground | | | |
|---|---|---|---|---|---|---|---|---|---|---|
| | | | | | | | SF | | | |
| | Prolia | | IsoClear | | | | White | Prolia | Prolia | Prolia |
| | 200/90 | GLY | 42% | NaOH | Na₂SO₃ | Borax | Flake | 100/90 | 200/70 | 200/20 |
| | (wt %) | (wt %) | (wt %) | (wt %) | (wt %) | (wt %) | (wt %) | (wt %) | (wt %) | (wt %) |
| Formula 86 | 60% | 20% | 10% | 3% | 2% | 5% | — | — | — | — |
| Formula 87 | 60% | 20% | 10% | 3% | 2% | 5% | — | — | — | — |
| Formula 88 | 57% | 20% | 10% | 6% | 2% | 5% | — | — | — | — |
| Formula 89 | — | 20% | 10% | 6% | 2% | 5% | 57% | — | — | — |
| Formula 90 | — | 20% | 10% | 6% | 2% | 5% | — | — | 57% | — |
| Formula 91 | — | 20v | 10% | 6% | 2% | 5% | 57% | — | — | 57% |
| Formula 92 | 57% | 30% | — | 6% | 2% | 5% | — | — | — | — |
| Formula 93 | — | 30% | — | 6% | 2% | 5% | — | 57% | — | — |
| Formula 94 | 60% | 30% | — | 3% | 2% | 5% | — | — | — | — |
| Formula 95 | 60% | 30% | — | 3% | 2% | 5% | — | — | — | — |
| Formula 96 | 60% | 30% | — | 3% | 2% | 5% | — | — | — | — |
| Formula 97 | 60% | 30% | — | 3% | 2% | 5% | — | — | — | — |
| Formula 98 | 60% | 30% | — | 3% | 2% | 5% | — | — | — | — |
| Formula 99 | 60% | 30% | — | 3% | 2% | 5% | — | — | — | — |
| Formula 100 | 62% | 30% | — | 3% | 2% | 3% | — | — | — | — |
| Formula 101 | 62% | 30% | — | 6% | 2% | — | — | — | — | — |
| Formula 102 | 50% | 40% | — | 3% | 2% | 5% | — | — | — | — |
| Formula 103 | 67% | 20% | — | 6% | 2% | 5% | — | — | — | — |
| Formula 104 | 57% | 30% | — | 6% | 2% | 5% | — | — | — | — |
| Formula 105 | 67% | 20% | — | 6% | 2% | 5% | — | — | — | — |
| Formula 106 | 57% | 20% | 10 | 6% | 2% | 5% | — | — | — | — |
| Formula 107 | 47% | 30% | 10% | 6% | 2% | 5% | — | — | — | — |
| Formula 108 | 66.8% | 20.0% | 0.0 | 6.0% | 1.9% | 5.2% | — | — | — | — |
| Formula 109 | 56.8% | 30.0% | 0.0 | 6.0% | 1.9% | 5.2% | — | — | — | — |
| Formula 110 | 56.8% | 20.0% | 10.0% | 6.0% | 1.9% | 5.2% | — | — | — | — |
| Formula 111 | 46.9% | 40.0% | 0.0 | 6.0% | 2.0% | 5.2v | — | — | — | — |
| Formula 112 | 46.9% | 29.9% | 10.1% | 6.0% | 1.9% | 5.2% | — | — | — | — |
| Formula 113 | 36.9% | 50.0% | 0.0% | 6.0% | 1.9% | 5.2% | — | — | — | — |

### Example 21

TABLE 24

| | Formula | Formula | Formula | Formula | Formula | Formula |
|---|---|---|---|---|---|---|
| | 108 | 109 | 110 | 111 | 112 | 113 |
| MOR, PSI | 710 | 617 | 786 | 656 | 749 | 567 |
| MOE, PSI | 76885 | 63493 | 86906 | 66462 | 88527 | 62246 |
| Thickness Swell (2 hr), % | 74% | 63% | 59% | 53% | 49% | 49% |
| Panel density g/cm³ | 0.629 | 0.612 | 0.633 | 0.624 | 0.627 | 0.620 |

| | |
|---|---|
| Press Temp, C. | 170 |
| Soak Time, s | 120 |
| Binder Dose (per 100 | 13 |
| parts of the dry weight of | |
| the WF) | |
| Mat Moisture (wt %) | 12% |
| Protocol | 2A |

Example 21 shows that it is possible to add fructose along with glycerol to produce an engineered wood particle board having acceptable physical properties (MOE, MOR, and Thickness Swell).

### Example 22

TABLE 25

| | Formula 86 | Formula 87 | Formula 88 |
|---|---|---|---|
| Soak time, s | 200 | 118 | 118 |
| Press Temp, C. | 160 | 187.7 | 215.7 |
| IB PSI | 52.4 | 62.5 | 88.2 |

| | |
|---|---|
| Binder Dose (per 100 parts of the | 13 |
| dry weight of the WF | |
| Mat Moisture (wt %) | 11% |
| Protocol | 2A |

Example 22 shows that an increased soak time, increased press temperature, or both can lead to improved internal bond strength in the engineered wood particle board.

### Example 23

TABLE 26

| | Formula | Formula | Formula | Formula |
|---|---|---|---|---|
| | 89 | 88 | 90 | 91 |
| IB PSI | 95 | 88 | 86 | 57 |

| | |
|---|---|
| Press Temp, C. | 212 |
| Press Time, s | 118 |
| Binder Dose (per 100 parts | 13 |
| of the dry weight of the WF | |
| Mat Moisture (wt %) | 11% |
| Protocol | 2A |

Example 23 shows that increasing the PDI of the polypeptide-containing component leads improved internal bond strength properties of the engineered wood particle board.

### Example 24

TABLE 27

| | Formula 92 | Formula 93 |
|---|---|---|
| Protein Flour | SF200-90 | SF100-90 |
| IB PSI | 67 | 68 |

| | |
|---|---|
| Press Temp, C. | 187.7 |
| Press Time, s | 120 |
| Binder Dose (per 100 parts of the | 13 |
| dry weight of the WF | |
| Mat Moisture (wt %) | 11% |
| Protocol | 2A |

Example 24 shows that the particle size of the polypeptide-containing (100-mesh vs 200-mesh) component used does not significantly affect the internal bond strength of the engineered wood particle board.

### Example 25

TABLE 28

| | Binder Dose (per 100 | | |
|---|---|---|---|
| | parts of the dry | | IB, |
| | weight of the WF) | Protocol | PSI |
| Formula 94 | 7 | 2B | 41.4 |
| Formula 95 | 7 | 2A | 57.8 |
| Formula 96 | 8 | 2B | 60.7 |
| Formula 97 | 9 | 2B | 61.0 |
| Formula 98 | 9 | 2A | 63.9 |
| Formula 99 | 10 | 2B | 69.8 |
| Formula 104 | 13 | 2A | 116 |

| | |
|---|---|
| Press Temp, F. | 213 |
| Soak Time, S | 110 |
| Matt Moisture (wt %) | 11% |

Example 25 shows that increased binder dose leads to improved internal bond strength in the engineered wood particle board. Example 26 also shows that at lower binder doses (7 parts per 100 parts of the dry weight of the wood fiver) protocol 2A produced an engineered wood particle board having better internal bond strength in the engineered wood particle board.

### Example 26

TABLE 29

| | Binder Dose | | |
|---|---|---|---|
| | (per 100 parts of | | |
| | the dry weight | GLY | IB, |
| | of the WF) | (wt %) | PSI |
| Formula 98 | 9 | 30% | 64 |
| Formula 102 | 9 | 40% | 60 |
| Formula 103 | 13 | 20% | 86 |
| Formula 104 | 13 | 30% | 116 |

| | |
|---|---|
| Press Temp, C. | 213 |
| Press Time, s | 110 |
| Mat Moisture (wt %) | 11% |
| Protocol | 2A |

Example 26 shows that increased GLY content (wt %) leads to engineered wood particle boards having improved internal bond strengths.

### Example 27

TABLE 30

| | Formula | Formula | Formula | Formula |
|---|---|---|---|---|
| | 105 | 88 | 106 | 107 |
| GLY (wt %) | 20 | 20 | 30 | 30 |
| IsoClear 42% (wt %) | 0 | 10 | 0 | 10 |
| IB psi | 99.5 | 88.2 | 88.4 | 87.2 |

| | |
|---|---|
| Press Temp, C. | 213 |
| Press Time, s | 118 |
| Binder Dose (per 100 parts | 13 |
| of the dry weight of the | |
| WF) | |
| Mat Moisture % | 11% |
| Protocol | 2A |

Example 27 shows that while including IsoClear 42% with GLY provides engineered wood particle boards having acceptable internal bond strength values, it was possible to produce engineered wood particle boards having acceptable internal bond strength values without including IsoClear 42%.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### Exemplary Aspects

The following exemplary aspects are provided, the numbering of which is not to be construed as designating levels of importance:

Aspect 1 provides an engineered wood precursor mixture comprising:
a plurality of wood components; and
a binder reaction mixture present in a range of from 3 parts to 25 parts per 100 parts of the dry weight of the plurality of wood components, the binder reaction mixture comprising:
   an aqueous portion comprising a glycerol component comprising glycerol or an oligomer of glycerol, the glycerol component present in a range of from 5 wt % to 65 wt % or 5 wt % to 50 wt %, based on the dry weight of the binder reaction mixture; and
   an at least partially non-dissolved polypeptide-containing component comprising soy flour, wheat gluten, corn protein isolate, or a mixture thereof, in a range of from 20 wt % to 85 wt %, based on the dry weight of the binder reaction mixture.

Aspect 2 provides an engineered wood precursor mixture comprising:
a plurality of wood components;
a binder reaction mixture present in a range of from 3 parts to 25 parts per 100 parts of the dry weight of the plurality of wood components, the binder composition comprising:
   an aqueous portion comprising:
      a glycerol component comprising glycerol or an oligomer of glycerol, the glycerol component present in a range of from 5 wt % to 65 wt % or 5 wt % to 50 wt %, based on the dry weight of the binder reaction mixture:
      a base in a range of 1 wt % to 33 wt % of a base, based on a dry weight of the binder reaction mixture:
      optionally, a carbohydrate-containing component in a range of from 2 wt % to 30 wt %, based on a dry weight of the binder reaction mixture, the carbohydrate-containing component comprising glucose, fructose, sucrose, or a mixture thereof, and the combined wt % of glucose, fructose, sucrose, or mixture thereof in the carbohydrate-containing component is at least 60 wt %;
      optionally, sodium sulfite in a range of from 0.5 wt % to 10 wt %, based on a dry weight of the binder reaction mixture; and
   an at least partially non-dissolved polypeptide-containing component comprising soy flour, wheat gluten, corn protein isolate, or a mixture thereof, in a range of from 20 wt % to 85 wt %, based on the dry weight of the binder reaction mixture.

Aspect 3 provides a method of making an engineered wood, the method comprising:
(a) mixing a glycerol component comprising glycerol or an oligomer of glycerol, water, a base, and optionally, sodium sulfite, a carbohydrate-containing component, borax, sodium trimetaphosphate, or a mixture thereof, to produce a first mixture;
(b) mixing the first mixture produced at (a) with a plurality of wood components to obtain a second mixture;
(c) mixing the second mixture produced at (b) with a polypeptide-containing component to form a third mixture; and
(d) curing the third mixture formed at (c) to form the engineered wood.

Aspect 4 provides an engineered wood comprising a reaction product of the engineered wood precursor mixture of any one of Aspects 1 or 2 or formed by the method of aspect 3.

1. An engineered wood precursor mixture for the manufacture of particle board, the mixture comprising:
a plurality of wood components; and
a binder reaction mixture present in a range of from 3 parts to 25 parts per 100 parts of the dry weight of the plurality of wood components, the binder reaction mixture comprising:
an aqueous portion comprising a glycerol component comprising glycerol, the glycerol component being present in a range of from 5 wt % to 65 wt % or 5 wt % to 50 wt %, based on the dry weight of the binder reaction mixture; and
an at least partially non-dissolved polypeptide-containing component comprising soy flour, in a range of from 20 wt % to 85 wt %, based on the dry weight of the binder reaction mixture.

2. The engineered wood precursor mixture of claim 1, wherein the aqueous portion further comprises 1 wt % to 33 wt % of a base comprising sodium hydroxide, based on a dry weight of the binder reaction mixture.

3. The engineered wood precursor mixture of claim or 2, wherein the aqueous portion further comprises 3 wt % to 10 wt % of a base comprising sodium hydroxide, based on a dry weight of the binder reaction mixture.

4. (canceled)

5. The engineered wood precursor mixture of claim 2, wherein the pH of the aqueous portion is in a range of from 10 to 14.

6. The engineered wood precursor mixture of claim 5, wherein the pH of the aqueous portion is in a range of from 11 to 14.

7. The engineered wood precursor mixture of claim 1 wherein the glycerol component is in a range of from 20 wt % to 55 wt %, based on a dry weight of the binder reaction mixture.

8. The engineered wood precursor mixture of claim 1, wherein the glycerol component is in a range of from 25 wt % to 40 wt %, based on a dry weight of the binder reaction mixture.

9-11. (canceled)

12. The engineered wood precursor mixture of claim 1, wherein the aqueous portion comprises sodium sulfite, sodium bisulfite, sodium metabisulfite, or a mixture thereof.

13-21. (canceled)

22. The engineered wood precursor mixture of claim 1, wherein the binder reaction mixture is present in a range of from 6 parts to 17 parts per 100 parts of the dry weight of the plurality of wood components.

23. The engineered wood precursor mixture of claim 1, wherein a moisture content of the binder reaction mixture that is applied to the plurality of wood components is in a range of from 7 wt % to 25 wt %.

24. (canceled)

25. The engineered wood precursor mixture of claim 1, further comprising borax.

26.-60. (canceled)

61. The engineered wood precursor mixture of claim 1, wherein the soy flour comprises from 40 wt % to 65 wt % protein, based on the total soy flour present.

62. The engineered wood precursor mixture or the method of claim 61, wherein the soy flour comprises from 20 wt % to 85 wt % of the dry weight of the binder reaction mixture.

63.-96. (canceled)

97. The engineered wood precursor mixture of claim 1, wherein the aqueous portion further comprises sodium trimetaphosphate.

98.-107. (canceled)

108. An engineered wood comprising particle board, formed by curing the engineered wood precursor mixture at a temperature of at least 204° C. (for example 204° C. to 226° C. or 204° C. to 248° C.).

109. (canceled)
